(19) United States
(12) Patent Application Publication
(10) Pub. No.: US 2019/0094725 A1
(43) Pub. Date: Mar. 28, 2019

(54) ELECTROPHOTOGRAPHIC PHOTORECEPTOR AND IMAGE FORMING APPARATUS

(71) Applicant: Konica Minolta, Inc., Tokyo (JP)

(72) Inventors: Tomoko Sakimura, Tokyo (JP); Hiroki Takao, Tokyo (JP); Mayuko Matsusaki, Tokyo (JP); Kengo Ikeda, Kitamoto-shi (JP)

(21) Appl. No.: 16/056,626

(22) Filed: Aug. 7, 2018

(30) Foreign Application Priority Data
Sep. 26, 2017 (JP) 2017-184467

(51) Int. Cl. G03G 5/147; G03G 15/00

(52) U.S. Cl. CPC G03G 5/14734; G03G 15/75

(57) ABSTRACT

Provided is an electrophotographic photoreceptor containing a conductive support having thereon a photosensitive layer and a protective layer located on the photosensitive layer, wherein the protective layer contains a polymerized and cured product of a composition incorporating: a polymerizable monomer, a polymerizable perfluoropolyether compound, and metal oxide particles surface-modified with a surface modifying agent containing a fluorine atom.

Japanese Patent Application No. 2017-184467, filed on Sep. 26, 2017 with Japan Patent Office, is incorporated herein by reference in its entirety.

### TECHNICAL FIELD

The present invention relates to an electrophotographic photoreceptor and an image forming apparatus. In particular, the present invention relates to an electrophotographic photoreceptor which is excellent in abrasion resistance, having a sustained high cleaning property, and capable of restraining generation of image defect caused by uneven abrasion. The present invention also relates to an image forming apparatus that is equipped with this electrophotographic photoreceptor.

### BACKGROUND

In recent years, in the field of electrophotographic image formation, the demand for images of high definition and high image quality has been increased. Therefore, the use of small particle size toner is a mainstream. However, the small particle size toner has a large adhesion force to the surface of an image carrier such as a photoreceptor and an intermediate transfer member. As a result, removal of the transfer residual toner tends to be insufficient. For example, in a cleaning method using a rubber blade, since toner slipping easily occurs, it is possible to prevent this by increasing the contact pressure of the blade against the image carrier. However, there arises a problem that the surface of the image carrier is worn by repeated use, and the durability of the image carrier becomes insufficient.

Therefore, as a device for reducing the adhesion force between the surface of the image carrier and the toner, and increasing the cleaning property, it has been proposed to as a fluorine-based material such as fluorine-based particles and fluorine-based lubricant to the surface of the image carrier. However, the addition of a fluorine-based material tends to cause deterioration of mechanical properties such as abrasion resistance and scratch resistance of the image carrier. Further, the fluorine-based material tends to exist at a high concentration in the vicinity of the surface of the image carrier due to its high surface orientation property. Therefore, although it exhibits high cleaning property at the initial using stage of the image carrier, its cleaning property is lowered when the surface of the image carrier is depleted by repeated use.

To solve this problem, addition of a perfluoropolyether compound and metal oxide particles to the protective layer of the image carrier has been proposed in order to achieve both abrasion resistance and durability of high cleaning performance of the photoreceptor (refer to: JP-A 2012-128324; JP-A 2015-028613; and JP-A 2015-184489, for example).

In recent years, in the field of electrophotographic printers and multifunctional peripherals, it is required to stably output printed matters having various printing ratios, such as small lot printed matter and full solid image printed matter, over a long period of time. However, according to the above-described conventional technologies, when continuously printing an image with a high coverage ratio, the photosensitive member is locally depleted (hereafter, it is also referred to as uneven abrasion) by the external additive slipped through at the cleaning portion, there may occur stripes (image defects) having different densities on the image.

### SUMMARY

The present invention was done based on the above-described problems and situations. An object of the present invention is to provide an electrophotographic photoreceptor which is excellent in abrasion resistance, having a sustained high cleaning property, and is capable of restraining generation of image defect caused by uneven abrasion. An object of the present invention is also to provide an image forming apparatus equipped with this electrophotographic photoreceptor.

In order to solve the above-described problem relating to the present invention, the reason of the above-described problem has been investigated. As a result, it has been found an electrophotographic photoreceptor which is excellent in abrasion resistance, having a sustained high cleaning property, and is capable of restraining generation of image defect caused by uneven abrasion. This electrophotographic photoreceptor comprises a conductive support having thereon a photosensitive layer and a protective layer located on the photosensitive layer, wherein the protective layer contains a polymerized and cured product of a composition incorporating: a polymerizable monomer, a polymerizable perfluoropolyether (PFPE) compound, and metal oxide particles surface-modified with a surface modifying agent containing a fluorine atom.

Namely, an object of the present invention is solved by the following means.

An aspect of the present invention is an electrophotographic photoreceptor comprising a conductive support having thereon a photosensitive layer and a protective layer located on the photosensitive layer,

wherein the protective layer contains a polymerized and cured product of a composition incorporating: a polymerizable monomer, a polymerizable perfluoropolyether (PFPE) compound, and metal oxide particles surface-modified with a surface modifying agent (modifier) containing a fluorine atom.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic cross-sectional drawing illustrating an example of an electrophotographic photoreceptor of the present invention.

FIG. 2 is a schematic configuration drawing illustrating an example of an image forming apparatus equipped with an electrophotographic photoreceptor of the present invention

### DETAILED DESCRIPTION OF THE EMBODIMENTS

Hereinafter, one or more embodiments of the present invention will be described with reference to the drawings. However, the scope of the invention is not limited to the disclosed embodiments.

The present invention enables to provide an electrophotographic photoreceptor which is excellent in abrasion resistance, having a sustained high cleaning property, and capable of restraining generation of image defect caused by uneven abrasion. The present invention also enables to provide an image forming apparatus equipped with this electrophotographic photoreceptor.

An expression mechanism or an action mechanism of the effects of the present invention is not clearly identified, but it is supposed as follows.

In an electrophotographic photoreceptor of the present invention, since a polymerizable monomer, a polymerizable perfluoropolyether compound both are polymerizable, these compounds react with each other to form a cross-linked structure. Consequently, it is possible to make the perfluoropolyether component to be easily present throughout the entire bulk of the protective layer. Therefore, even after the outermost surface of the protective layer is depleted by the use of the electrophotographic photoreceptor, it is possible to keep a perfluoropolyether component in an amount sufficient for maintaining high cleaning performance on the peripheral surface of the protective layer.

Further, in the protective layer of the electrophotographic photoreceptor of the present invention, since the resin portion comprising the polymerized and cured product of the polymerizable monomer and the polymerizable perfluoropolyether compound is softer than the metal oxide particle portion, it is preferentially depleted by repeatedly usage. As a result, the metal oxide particles are exposed on the surface of the protective layer. However, since the metal oxide particles are surface-modified with a surface modifying agent containing a fluorine atom, low adhesion property of the toner is maintained. As a result, it is presumed that the cleaning property of the surface of the electrophotographic photoreceptor can be further enhanced.

Further, since this makes it possible to further reduce the toner adhesion property to the surface of the electrophotographic photoreceptor, the toner transfer ratio is improved, and the amount of transfer residual toner (that is, the amount of toner reaching the cleaning blade) decreases. It is presumed that the uneven abrasion of the photoreceptor is suppressed when the image having a high printing ratio is continuously printed.

An electrophotographic photoreceptor of the present invention is a photoreceptor comprising a conductive support having thereon a photosensitive layer and a protective layer located on the photosensitive layer. The aforesaid protective layer is characterized in containing a polymerized and cured product of a composition incorporating: a polymerizable monomer, a polymerizable perfluoropolyether compound, and metal oxide particles surface-modified with a surface modifying agent. containing a fluorine atom. This is a technical feature commonly owned by the embodiments described in the following.

In the present invention, it is preferable that the surface modifying agent containing a fluorine atom includes a fluoroalkyl (meth)acrylate/(meth)acrylic acid copolymer.

Thereby, the surface modifying agent containing a fluorine atom may be present on the surface of the metal oxide particles with high adhesion state. Since a high fluorine density may be obtained, occurrence of image defects caused by uneven abrasion can be more reliably suppressed.

In the present invention, it is preferable that the fluoroalkyl (meth)acrylate/(meth)acrylic acid copolymer has both a structure unit represented by Formula (1a) and a structure unit represented by Formula (1b) described below. Thereby, the surface modifying agent containing a fluorine atom may be present on the surface of the metal oxide particles with high adhesion state. Since a high fluorine density may be obtained, occurrence of image defects caused by uneven abrasion can be more reliably suppressed.

In the present invention, it is preferable that the metal oxide particles surface-modified with the surface modifying agent containing a fluorine atom has a polymerizable group. Thereby, since the metal oxide particles exist in a state of being chemically bonded to the integral polymer constituting the protective layer, the strength of the protective layer may be improved. Therefore, the abrasion resistance of the electrophotographic photoreceptor can be further improved.

In the present invention, it is preferable that the metal oxide particles which are surface-modified with the surface modifying agent containing a fluorine atom has a number average primary particle size in the range of 50 to 200 nm. Thereby excellent abrasion resistance can be more reliably obtained. When a protective layer is formed by coating a coating liquid, sedimentation of metal oxide particles in the coating liquid may be suppressed and a uniform protective layer is likely formed. As a result, improved cleaning property may be obtained.

In the present invention, it is preferable that the aforesaid polymerizable perfluoropolyether compound has a structure represented by Formula (2). Thereby, the abrasion resistance of the electrophotographic photoreceptor can be further improved, and the high cleaning performance can be maintained more reliably.

Further, an image forming apparatus of the present invention is characterized in being equipped with the above-described electrophotographic photoreceptor. Thereby it is possible to suppress generation of image defect over a long period of time.

The present invention and the constitution elements thereof, as well as configurations and embodiments, will be detailed in the following. In the present description, when two figures are used to indicate a range of value before and after “to”, these figures themselves are included in the range as a lowest limit value and an upper limit value.

### <<Outline of Electrophotographic Photoreceptor>>

An electrophotographic photoreceptor of the present invention is a photoreceptor including a conductive support having thereon a photosensitive layer and a protective layer located on the photosensitive layer, it is characterized in that the protective layer contains a polymerized and cured product of a composition incorporating: a polymerizable monomer, a polymerizable perfluoropolyether compound, and metal oxide particles surface-modified with a surface modifying agent.

A conductive support is a member that is capable of supporting the photosensitive layer, and has an electric conductivity. Examples of a conductive support are: a metal drum or sheet, a plastic film having a laminated metal foil, a plastic film having a film of a vapor deposited conductive material, a metal member or a plastic film having a conductive layer formed by coating a paint composed of a conductive substance or a conductive substance with a binder resin, and a paper. Examples of a metal are: aluminum, copper, chromium, nickel, zinc, and stainless steel. Examples of a conductive substance are: the above-described metals, indium oxide, and tin oxide.

A photosensitive layer is a layer for forming an electrostatic latent image of a required image by light exposure described later on an electrophotographic photoreceptor (hereafter, it may be called as a photoreceptor). The photosensitive layer may be composed of a single layer, or may be formed by laminating a plurality of layers. For examples, a single layer constitution that contains a charge transport compound and a charge generation compound; and a laminate constitution composed of a charge transport layer containing a charge transport compound and a charge generation layer containing a charge generation compound.

In addition, the photoreceptor may further include other constituting member than the conductive support, the photosensitive layer, and the protective layer, within the range where the effect of the embodiment of the present invention may be obtained. As the other constituting member, it may be cited an intermediate layer disposed between the conductive support and the photosensitive layer, and having a barrier function and an adhesion function.

Each member constituting the photoreceptor other than the protective layer may be constituted in the same manner as the known organic photoreceptor.

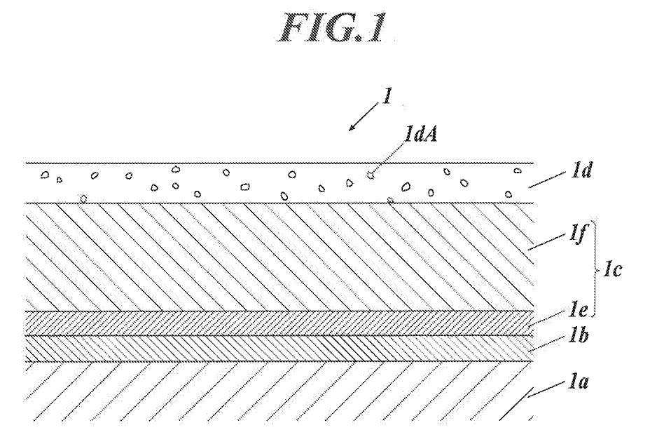

FIG. 1 is a schematic cross-sectional drawing illustrating an example of an electrophotographic photoreceptor in the embodiment of the present invention.

As illustrated in FIG. 1, the electrophotographic photoreceptor 1 in the embodiment of the present invention is configured to include a conductive support 1a having thereon an intermediate layer 1b, a photosensitive layer 1c and a protected layer 1d sequentially laminated in that order.

The photosensitive layer 1c is composed of a charge generation layer 1e and a charge transport layer 1f.

The protective layer 1d contains a metal oxide particle 1dA.

### <<Protective Layer>>

The protective layer is a layer for protecting photosensitive layer. It is disposed on the photosensitive layer and it constitutes a surface of the photosensitive layer. The protective layer contains a polymerized and cured product of a composition incorporating: a polymerizable monomer, a polymerizable perfluoropolyether compound, and metal oxide particles surface-modified with a surface modifying agent containing a fluorine atom. The protective layer is composed of an integral polymer by polymerization of a polymerizable monomer. The perfluoropolyether component and the metal oxide particles are dispersed inside of the protective layer. The perfluoropolyether component is bonded to the polymer by a covalent bond through a polymerization reaction. The polymerizable monomer, the polymerizable perfluoropolyether compound, and metal oxide particles may be used singly, or may be used in combination of two or more kinds.

In the following, materials for constituting the protective layer will be described in detail.

### <<Polymerizable Monomer>>

The polymerizable monomer according to the present invention is a compound having a polymerizable group, and it is polymerized (cured) by irradiation with active rays such as UV rays, visible rays, and electron beams, or by addition of energy such as heating. The polymerizable monomer is a compound to become resin used for a binder resin of the photoreceptor. A polymerizable monomer in the present invention does not include a polymerizable perfluoropolyether compound.

The polymerizable monomer is preferably a radical polymerizable monomer which is cured through a radical polymerization reaction. Examples of a polymerizable monomer include: a styrene monomer, an acrylic monomer, a methacrylic monomer, a vinyltoluene monomer, a vinyl acetate monomer, and an N-vinylpyrrolidone monomer. As a binder resin, for example, polystyrene and polyacrylate are cited.

The polymerizable group that is possessed by the polymerizable monomer has a carbon-carbon double bond, and it is polymerizable. The polymerizable group is particularly preferable to be an acryloyl group (CH₂═CHCO—) or a methacryloyl group (CH₂═C(CH₃)CO—) since it can be cured with a small amount of light or in a short time.

Specific examples of a polymerizable monomer include the following compounds M1 to M11, but the present invention is not limited to them. In the following structures, R represents an acryloyl group, and R′ represents a methacryloyl group.

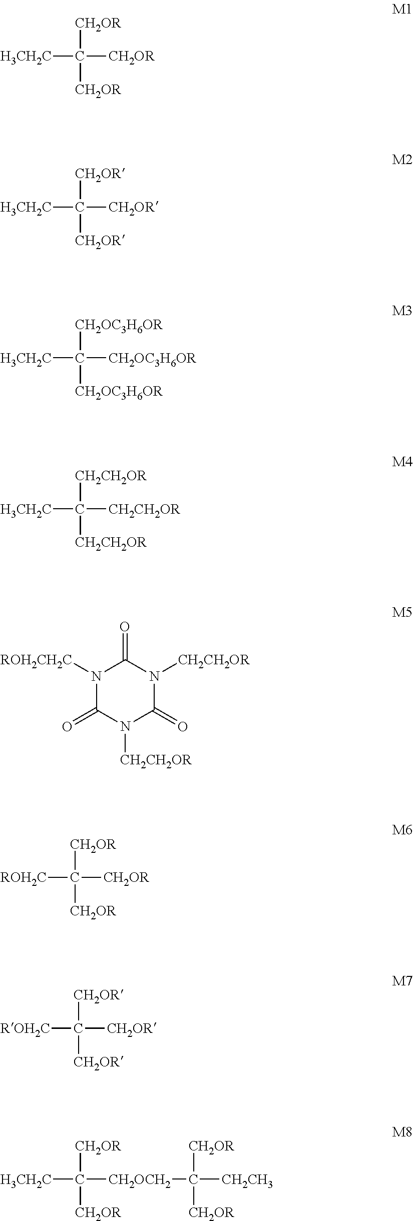

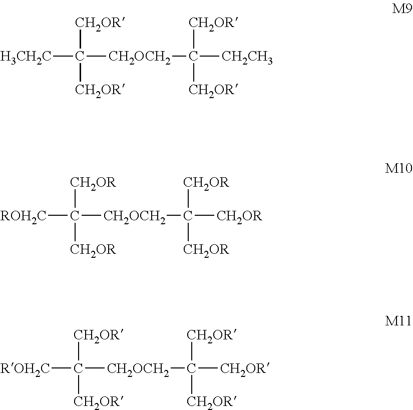

The above-described polymerizable monomers may be synthesized by a known method, and they may be obtained as a commercially available product.

The polymerizable monomer is preferably a compound having three or more polymerizable groups from the viewpoint of forming a protective layer of high hardness having a high crosslinking density.

### <<Polymerizable Perfluoropolyether Compound>>

A polymerizable perfluoropolyether (PFPE) compound is an oligomer or a polymer having a perfluoropolyether group as a repeating unit. Examples of a perfluoropolyether group as a repeating unit include: perfluoromethylene ether, perfluoroethylene ether, and perfluoropropylene ether.

When a plurality of structural units are used, a block copolymer structure may be formed or a random copolymer structure may be formed.

Since the polymerizable PFPE compound has a polymerizable group, it reacts with the above-described polymerizable monomer to form a polymerized and cured product. Thereby, the movement of the PFPE component to the surface may be suppressed and the PFPE component may be present over the entire thickness direction of the protective layer. The polymerizable PFPE compound is preferably a radical polymerizable PFPE compound which is cured through a radical polymerization reaction.

A number average molecular weight of the polymerizable PFPE compound is preferably in the range of 300 to 20,000, for example, and more preferably in the range of 500 to 20,000.

The polymerizable PFPE compound preferably has a structure represented by Formula (2) indicated below.

(X)_{q}-A-CF₂O(CF₂CF₂O)ₘ(CF₂O)ₙCF₂-A-(X)_{q} Formula (2)

In Formula (2), A represents a linking group having a (q+1) valence, and two As may be the same or different; X represents a polymerizable group, and a plurality of Xs may be the same or different; m and n each independently represent an integer of 0 or more, and (m+n)≥5; and q represents an integer of 1 or more, and a plurality of Xs may be the same or different.

Examples of a linking group represented by “A” in Formula (2) are the structures indicated in the following. In the following structures, “*1” in the following structure represents a linking position with a carbon atom at an end of the group “—CF₂O(CF₂CF₂O)ₘ(CF₂O)ₙCF₂—” in Formula (2), and “*2” in the following structure represents a linking position with “X” in Formula (2).

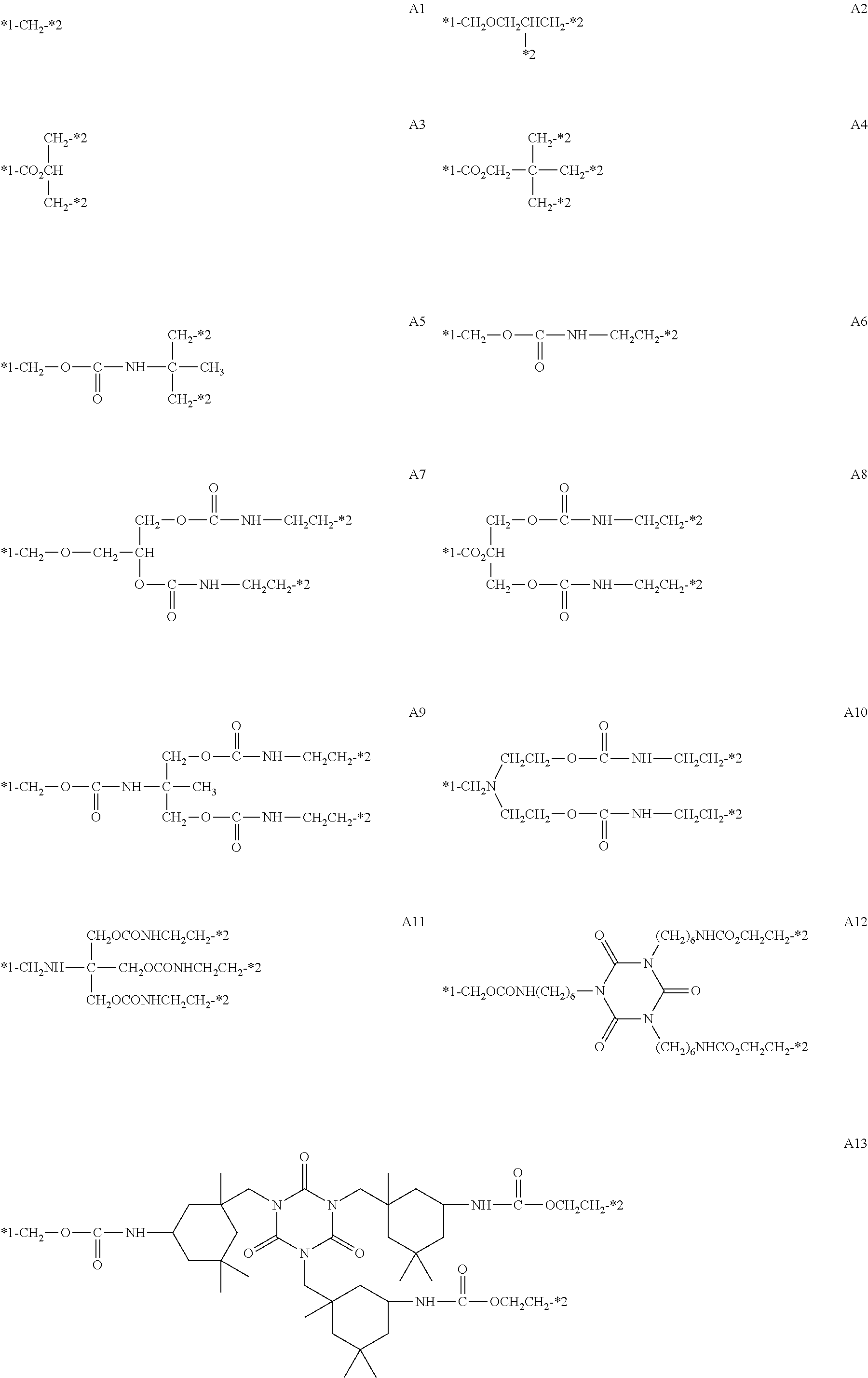

In the above-described Formula (2), as a polymerizable group represented by X, any polymerizable group having a carbon-carbon double bond may be used, for example, an acryloyl group, a methacryloyl group or the like is particularly useful.

In the above-described Formula (2), m and n each independently represent preferably an integer of 2 to 20, and more preferably an integer of 2 to 15.

In the above-described Formula (2), the perfluoroethylene ether structural unit and the perfluoromethylene ether structural unit may form a block copolymer structure or may form a random copolymer structure.

According to the structure represented by Formula (2), by having a polymerizable group at both ends of the PFPE chain, it reacts with the polymerizable monomer to form a higher-order crosslinked film, and at the same time, the movement of the PFPE component to the surface may be reliably suppressed, and it is easy to make the PFPE component more reliably present over the entire thickness direction of the protective layer. As a result, it is possible to improve the abrasion resistance and the cleaning property of the photoreceptor.

Specific examples of a polymerizable PFPE compound are listed below, but the present invention is not limited to them. The following PFPE-1 to PFPE-10 are specific examples of a polymerizable PFPE compound having the structure represented by Formula (2), and PFPE-11 and PFPE-12 below are other polymerizable PFPE compounds. In the following structures, X represents an acryloyloxy group or a methacryloyloxy group, m and n each independently represent an integer of 0 or more, and m+n≥5.

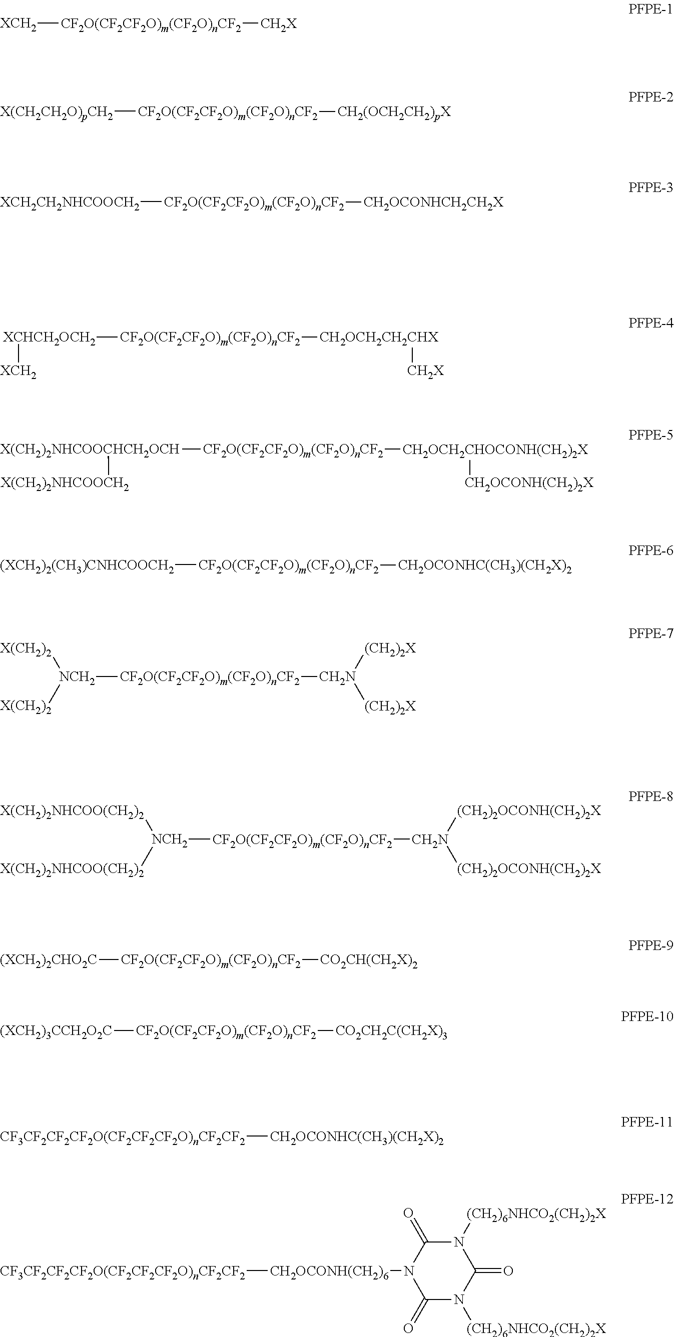

As a polymerizable PFPE compound, a commercially available product may also be used. Examples thereof are: Fluorolink™ AD 1700, MD500, MD700, 5101X, 5113X, and Fomblin™ MT70 (made by Solvay Specialty Polymers Co. Ltd.), OPTOOL™ DAC (made by Daikin Industries, Ltd.), KY-1203 (made by Shin-Etsu Chemical Co. Ltd.), MEGAFAC™ RS-78 and MEGAFAC™ RS-90 (made by DIC Co. Ltd.).

A polymerizable PFPE compound may be appropriately synthesized from a PFPE compound having a hydroxy group or a carboxy group at the terminal position of the molecule a as a raw material. Such a synthesized product may be used.

As a PFPE compound having a hydroxy group at the terminal, the following compounds may be used. Examples thereof are: Fomblin™ D2, Fluorolink™ D4000, Fluorolink™ E10H, 5158X, 5147X, Fomblin™ Ztetraol (made by Solvay Specialty Polymers Co. Ltd.) and Demnum™-SA (made by Daikin Industries, Ltd.).

As a PFPE compound having a carboxy group at the terminal, the following compounds may be used. Examples thereof are: Fomblin™ ZDIZAC4000 (made by Solvay Specialty Polymers Co. Ltd.) and Demnum™-SH (made by Daikin Industries, Ltd.).

A content of the polymerizable PFPE compound in a composition for forming a protective layer (a coating liquid for forming a protective layer that is described later) is preferably 10 mass parts or more with respect to 100 mass parts of polymerizable monomer from the viewpoint of fully acquiring high cleaning performance. From the viewpoint of fully acquiring abrasion resistivity, the content of the polymerizable PFPE compound in the coating liquid is preferably 100 mass parts or less, and more preferably, it is 70 mass parts or less.

<<Metal Oxide Particles Surface-Modified with a Surface Modifying Agent Containing a Fluorine Atom>>

The metal oxide particles surface-modified with a surface modifying agent containing a fluorine atom are obtained by applying surface modification treatment with a surface modifying agent containing a fluorine atom to unprocessed metal oxide particles as a raw material. Since the metal oxide particles surface-modified with a surface modifying agent containing a fluorine atom exhibit good dispersibility in a coating liquid for forming a protective layer described later, they also exhibit excellent dispersibility in a coated film. It is preferable that the metal oxide particles have a polymerizable group.

Tee surface modification treatment with a surface modifying agent containing a fluorine atom to unprocessed metal oxide particles is specifically done as follows. The unprocessed metal oxide particles or metal oxide particles having a polymerizable group are dispersed in an alcoholic media such as methanol or 2-butanol. To this is added a surface modifying agent containing a fluorine atom, and mixed. By volatilizing the dispersing medium, or by conducting heating treatment after volatilizing the dispersing medium, surface modification to metal oxide particles can be done.

Examples of a constituting material for unprocessed metal oxide particles are: silica (silicon oxide), magnesium oxide, zinc oxide, lead oxide, alumina (aluminum oxide), tin oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium dioxide, niobium oxide, molybdenum oxide, vanadium oxide, and copper aluminum oxide. Among them, preferably used materials are: alumina (Al₂O₃), tin oxide (SnO₂), titanium dioxide (TiO₂), and copper aluminum complex oxide (CuAlO₂). The constituting materials of the unprocessed metal oxide particles may be of one kind, or they may be of two or more kinds.

The unprocessed metal oxide particles may be complex particles having a core-shell structure which has an outer shell made of a metal oxide formed on a surface of a core material. As a substance of the core material, barium sulfate, alumina and silica are cited. From the viewpoint of securing transparency of the protective layer, barium sulfate is preferably used.

It is preferable that the metal oxide particles according to the embodiment of the present invention have a number average primary particle size in the range of 50 to 200 nm, for example. When the number average primary particle size is 50 nm or more, sufficient abrasion resistance may be obtained more reliably. When the number average primary particle size is 200 nm or less, during the time of dispersing metal oxide particles which are surface-modified with a surface modifying agent containing a fluorine atom, sedimentation of metal oxide particles in the dispersion liquid may be suppressed and a uniform protective layer is likely formed. As a result, improved cleaning property may be obtained.

The particle size distribution of the metal oxide particles according to the embodiment of the present invention may be appropriately adjusted within a range where the effect of the embodiment of the present invention may be obtained. The standard deviation a of the metal oxide particles is preferably in the range of 10 to 30 nm, for example.

The number average primary particle size of the metal oxide particles according to the embodiment of the present invention is determined as follows. The particles are photographed at a magnification of 10,000 times with a scanning electron microscope (manufactured by JEOL Ltd.), and the photographic image including randomly selected 300 particles (excluding agglomerated particles) of the metal oxide particles read by a scanner is converted into a binary image with an automatic image analyzer (“LUZEX™ AP” with software version Ver. 1.32, manufactured by NIRECO Corporation). The horizontal Feret's diameters of the metal oxide particles are calculated, and the average value of the Feret's diameters is defined as the number average primary particle size. Here, the “horizontal Feret's diameter” refers to the length of a side (parallel to the x-axis) of a circumscribed rectangle when an image of the metal oxide particles is subjected to a binary treatment.

A content of metal oxide particles surface-modified with a surface modifying agent containing a fluorine atom in a composition for forming a protective layer (a coating liquid for forming a protective layer that will be described later) is preferably 30 mass parts with respect to the total 100 mass parts of the polymerizable monomer and the polymerizable PFPE compound, from the viewpoint of exhibiting sufficient mechanical strength for the protective layer. From the viewpoint of exhibiting sufficient cleaning property for the protective layer, it is preferable that the content is 200 mass parts or less.

### [Surface Modifying Agent Containing a Fluorine Atom]

The above-described surface modifying agent containing a fluorine atom has a fluorine atom containing group and a surface modifying functional group.

Examples of a fluorine atom containing group are: a perfluoroalkyl group and a perfluoropolyether group.

Examples of a surface modifying functional group are: a carboxy group, a hydroxy group, and alkoxysilyl group.

It is preferable that the surface modifying agent containing a fluorine atom includes a fluoroalkyl (meth)acrylate/(meth)acrylic acid copolymer. It is preferable that this copolymer has both a structure unit represented by Formula (1a) and a structure unit represented by Formula (1b).

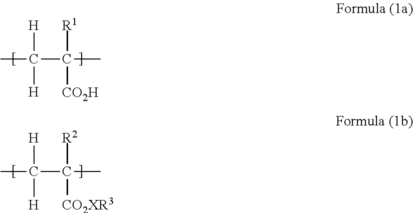

In Formula (1a) and Formula (1b), R¹ and R² each independently represents a hydrogen atom or a methyl group; X represents an alkylene group having 1 to 4 carbon atoms; and R³ represents a perfluoroalkyl group having 1 to 6 carbon atoms.

By having a structure unit represented by Formula (1a) and a structure unit represented by Formula (1b) in the surface modifying agent containing a fluorine atom, the surface modifying agent containing a fluorine atom may be present on the surface of the metal oxide particles with high adhesion state, and a high fluorine density may be obtained.

It is preferable that the surface modifying agent containing a fluorine atom has a number average molecular weight in the range of 5,000 to 30,000.

Examples of a surface modifying agent containing a fluorine atom are: 2,2,3,3,4,4,4-heptafluorobutyl methacrylate/acrylic acid copolymer, 2,2,3,3-tetrafluoropropyl methacrylate/acrylic acid copolymer, and 2,2,3,3,4,4,5,5,5-nonafluoropentyl methacrylate/acrylic acid copolymer.

These may be used alone, or they may be used by mixing two or more kinds.

The used amount of the surface modifying agent containing a fluorine atom is preferably 0.5 to 20 mass parts, more preferably 1 to 10 mass parts with respect to 100 mass parts of the unprocessed metal oxide particles.

The fact that the surface of the metal oxide particles is treated with a surface modifying agent containing a fluorine atom is confirmed with measurement by a differential thermal analysis and thermogravimetric analysis (TG/DTA).

### [Metal Oxide Particles Having a Polymerizable Group]

It is preferable that the metal oxide particles surface-modified with a surface modifying agent containing a fluorine atom further has a polymerizable group. By the presence of a polymerizable group on the metal oxide particles, the metal oxide particles may exist in a state of being chemically bonded to the integral polymer constituting the protective layer, a high-strength protective layer may be formed.

The loading of the polymerizable group on the metal oxide particles according to the embodiment of the present invention may be carried out by a known surface modification treatment. For example, a known surface treatment method using a surface treatment agent for metal oxide particles as described in JP-A 2012-078620 may be used.

As a preparation method of metal oxide particles according to the embodiment of the present invention, it is preferable to do as follows. After carrying out a surface modifying treatment to metal oxide particles with a surface modifying agent having a polymerizable group, a surface modifying treatment with a surface modifying agent containing a fluorine atom is carried out. When a surface modifying treatment with a surface modifying agent having a polymerizable group is carried out after carrying out a surface modifying treatment with a surface modifying agent containing a fluorine atom, it may not be possible to introduce a polymerizable group on the surface of the metal oxide particle due to the oil repellency given by the surface modifying agent containing a fluorine atom, which is not preferable. The surface modifying agent may be used singly or in combination of two or more kinds.

The surface modifying agent having a polymerizable group contains a polymerizable group and a surface modifying functional group. The surface modifying functional group is a group capable of reacting with a polar group such as a hydroxy group existing on the surface of the unprocessed metal oxide particles. Examples of a surface modifying functional group are: a carboxy group, a hydroxy group, and an alkoxy group. Examples of a polymerizable group is a group having a carbon-carbon double bond and capable of polymerizing. Examples thereof are: a vinyl group and a (meth)acryloyl group.

A preferred surface modifying agent having a polymerizable group is a silane coupling agent having a polymerizable group. Examples thereof include compounds S-1 to S-31 described in the following. However, the present invention is not limited to them.

CH₂═CHSi(CH₃)(OCH₃)₂ S-1

CH₂═CHSi(OCH₃)₃ S-2:

CH₂═CHSiCl₃ S-3

CH₂═CHCOO(CH₂)₂Si(CH₃)(OCH₃)₂ S-4

CH₂═CHCOO(CH₂)₂Si(OCH₃)₃ S-5

CH₂═CHCOO(CH₂)₂Si(OC₂H₅)(OCH₃)₂ S-6

CH₂═CHCOO(CH₂)₃Si(OCH₃)₃ S-7

CH₂—CHCOO(CH₂)₂Si(CH₃)Cl₂ S-8

CH₂═CHCOO(CH₂)₂SiCl₃ S-9

CH₂═CHCOO(CH₂)₃Si(CH₃)Cl₂ S-10

CH₂—CHCOO(CH₂)₃SiCl₃ S-11

CH₂═C(CH₃)COO(CH₂)₂Si(CH₃)(OCH₃)₂ S-12

CH₂═C(CH₃)COO(CH₂)₂Si(OCH₃)₃ S-13

CH₂═C(CH₃)COO(CH₂)₃Si(CH₃)(OCH₃)₂ S-14

CH₂═C(CH₃)COO(CH₂)₃Si(OCH₃)₃ S-15

CH₂═C(CH₃)COO(CH₂)₂Si(CH₃)Cl₂ S-16

CH₂═C(CH₃)COO(CH₂)₂SiCl₃ S-17

CH₂═C(CH₃)COO(CH₂)₃Si(CH₃)Cl₂ S-18

CH₂═C(CH₃)COO(CH₂)₃SiCl₃ S-19

CH₂═CHSi(C₂H₅)(OCH₃)₂ S-20

CH₂═C(CH₃)Si(OCH₃)₃ S-21

CH₂═C(CH₃)Si(OC₂H₅)₃ S-22

CH₂═CHSi(OCH₃)₃ S-23

CH₂═C(CH₃)Si(CH₃)(OCH₃)₂ S-24

CH₂═CHSi(CH₃)Cl₂ S-25

CH₂═CHCOOSi(OCH₃)₃ S-26

CH₂═CHCOOSi(OC₂H₅)₃ S-27

CH₂═C(CH₃)COOSi(OCH₃)₃ S-28

CH₂═C(CH₃)COOSi(OC₂H₅)₃ S-29

CH₂═C(CH₃)COO(CH₂)₃Si(OC₂H₅)₃ S-30

CH₂═CHCOO(CH₂)₂Si(CH₃)₂(OCH₃) S-31

### <<Other Additives>>

The protective layer or the composition for forming the protective layer of the embodiment of the present invention may contain other additives in addition to the above-described various materials. Examples of other additives include a charge transport material, a polymerization initiator, and a polymerization inhibitor.

### (Charge Transport Material)

The protective layer or the composition for forming the protective layer preferably further contains a charge transport material from the viewpoint of improving the memory resistance of the photoreceptor. From the viewpoint of hole transport property, the charge transport material is preferably a compound having a charge transport property that does not react with the above-described polymerizable monomer, the polymerizable PFPE compound, and the metal oxide particles surface-modified with a surface modifying agent containing a fluorine atom.

As a charge transport material, various known charge transport materials may be used. When ultraviolet light is used for curing treatment for forming the protective layer, it is preferable to use a material having no or small absorption of light in the short wavelength region of 450 nm or less.

As a charge transport material having no or small absorption of light in the short wavelength region of 450 nm or less, a compound represented by the following Formula (3) may be used.

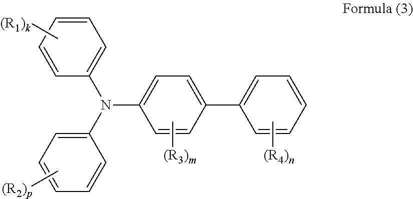

In the above-described Formula (3), R₁, R₂, R₃ and R₄ each independently represent a hydrogen atom, an alkyl group having 1 to 7 carbon atoms, or an alkoxy group having 1 to 7 carbon atoms. k, p, and n each independently represent an integer of 1 to 5. m represents an integer of 1 to 4. When k, p, m and n represent an integer of 2 or more, a plurality of groups may be the same or different.

Examples of a charge transport material represented by Formula (3) are the following compounds CTM-1 to CTM-22. However, the present invention is not limited to them.

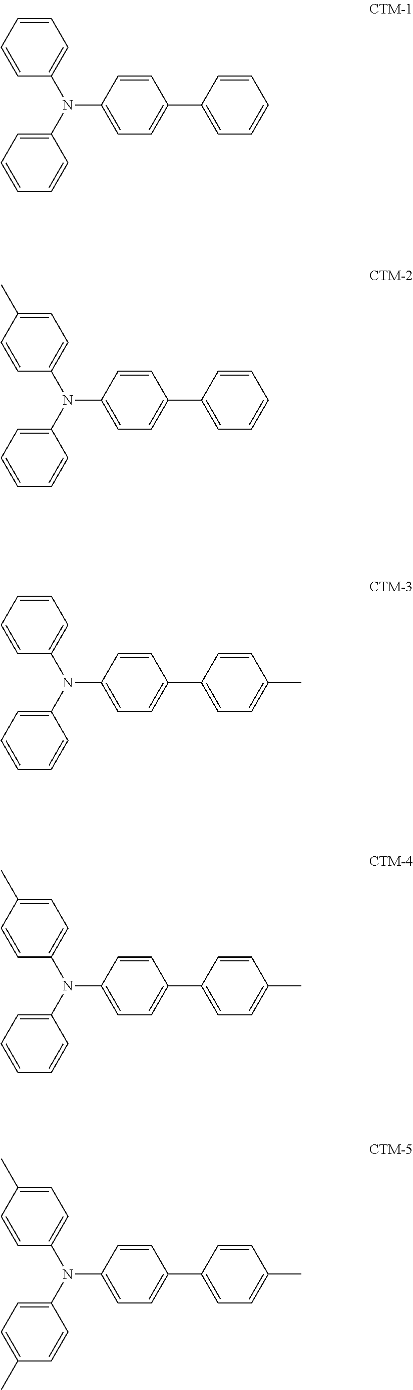 [SMILES: c1ccc(-c2ccc(N(c3ccccc3)c3ccccc3)cc2)cc1 ; Cc1ccc(N(c2ccccc2)c2ccc(-c3ccccc3)cc2)cc1 ; Cc1ccc(-c2ccc(N(c3ccccc3)c3ccccc3)cc2)cc1 ; Cc1ccc(-c2ccc(N(c3ccccc3)c3ccc(C)cc3)cc2)cc1 ; Cc1ccc(-c2ccc(N(c3ccc(C)cc3)c3ccc(C)cc3)cc2)cc1]

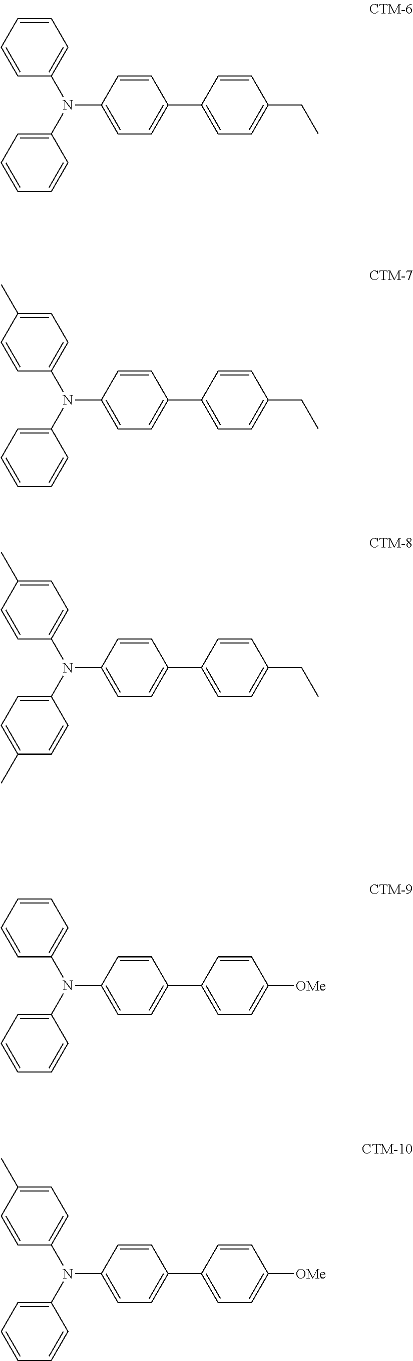 [SMILES: CCc1ccc(-c2ccc(N(c3ccccc3)c3ccccc3)cc2)cc1 ; CCc1ccc(-c2ccc(N(c3ccccc3)c3ccc(C)cc3)cc2)cc1 ; CCc1ccc(-c2ccc(N(c3ccc(C)cc3)c3ccc(C)cc3)cc2)cc1 ; COc1ccc(-c2ccc(N(c3ccccc3)c3ccccc3)cc2)cc1 ; COc1ccc(-c2ccc(N(c3ccccc3)c3ccc(C)cc3)cc2)cc1]

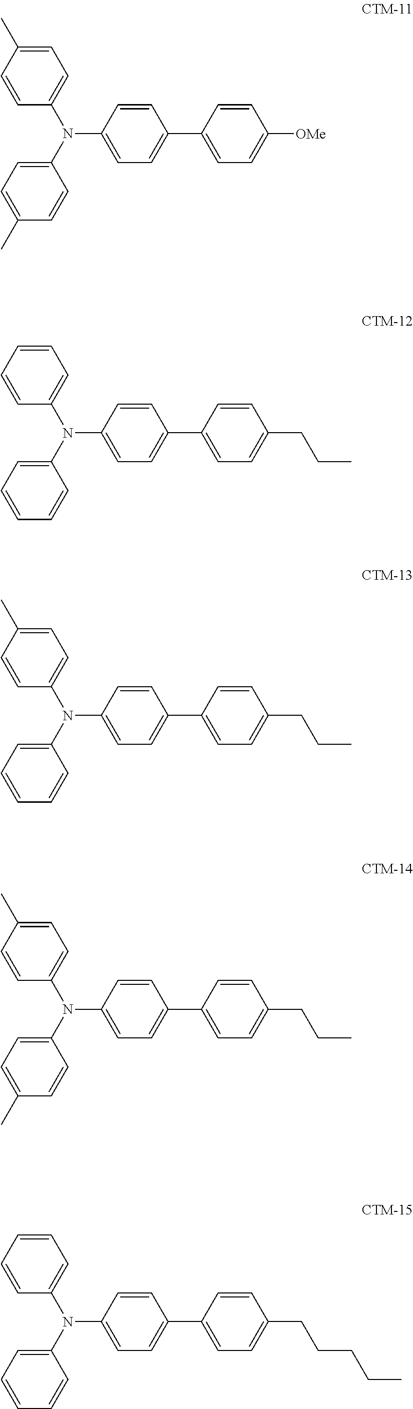 [SMILES: COc1ccc(-c2ccc(N(c3ccc(C)cc3)c3ccc(C)cc3)cc2)cc1 ; CCCc1ccc(-c2ccc(N(c3ccccc3)c3ccccc3)cc2)cc1 ; CCCc1ccc(-c2ccc(N(c3ccccc3)c3ccc(C)cc3)cc2)cc1 ; CCCc1ccc(-c2ccc(N(c3ccc(C)cc3)c3ccc(C)cc3)cc2)cc1 ; CCCCCc1ccc(-c2ccc(N(c3ccccc3)c3ccccc3)cc2)cc1]

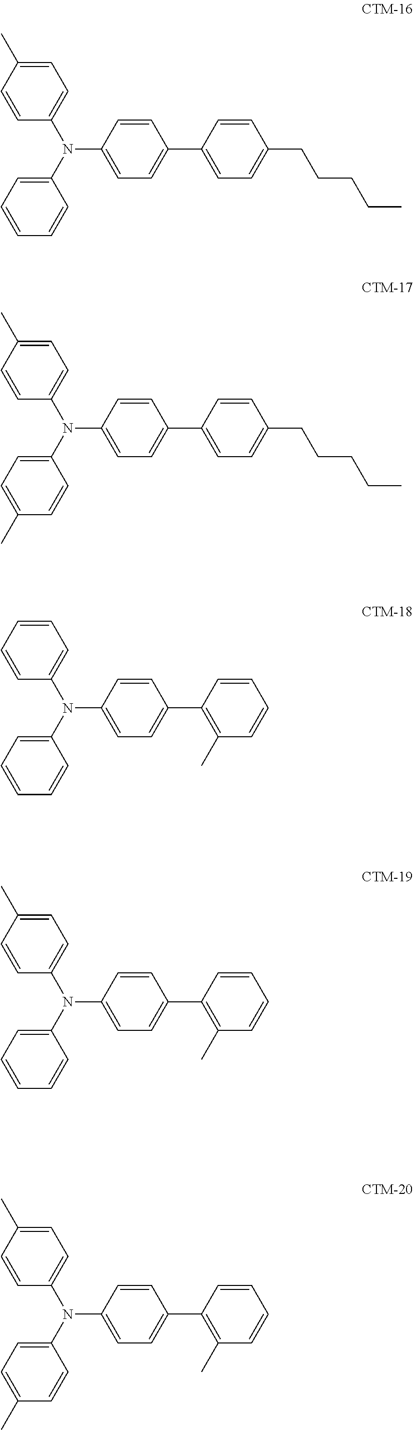 [SMILES: CCCCCc1ccc(-c2ccc(N(c3ccccc3)c3ccc(C)cc3)cc2)cc1 ; CCCCCc1ccc(-c2ccc(N(c3ccc(C)cc3)c3ccc(C)cc3)cc2)cc1 ; Cc1ccccc1-c1ccc(N(c2ccccc2)c2ccccc2)cc1 ; Cc1ccc(N(c2ccccc2)c2ccc(-c3ccccc3C)cc2)cc1 ; Cc1ccc(N(c2ccc(C)cc2)c2ccc(-c3ccccc3C)cc2)cc1]

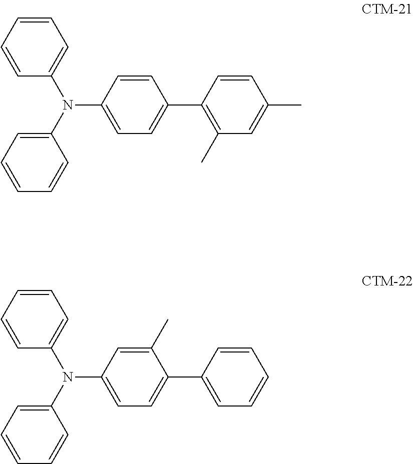 [SMILES: Cc1ccc(-c2ccc(N(c3ccccc3)c3ccccc3)cc2)c(C)c1 ; Cc1cc(N(c2ccccc2)c2ccccc2)ccc1-c1ccccc1]

Examples of a charge transport material that may be included in a protective layer or a composition for forming a protective layer are the charge transport material represented by Formula (3). Further, the following compounds CTM-23 to CTM-29 may be cited as examples. However, the present invention is not limited to them.

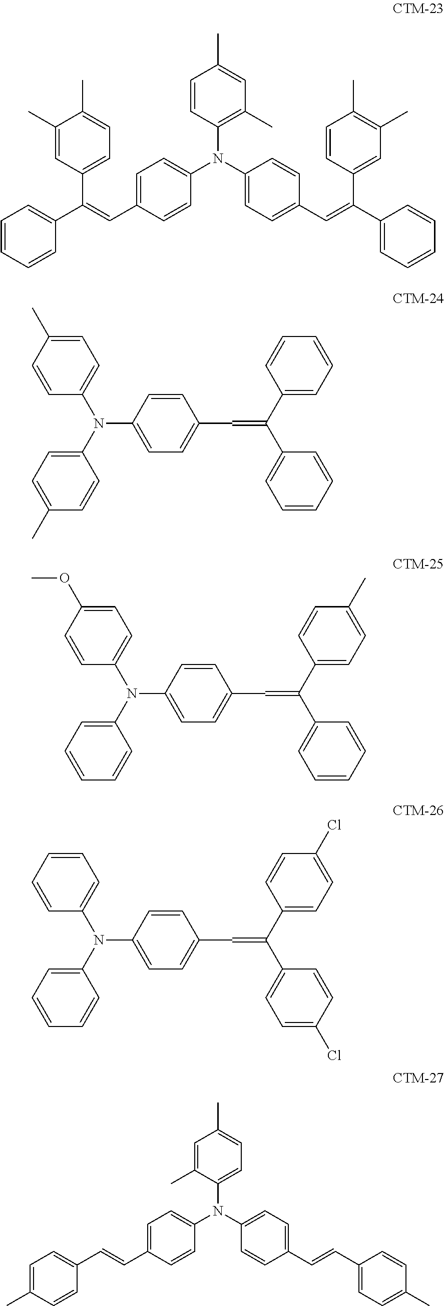

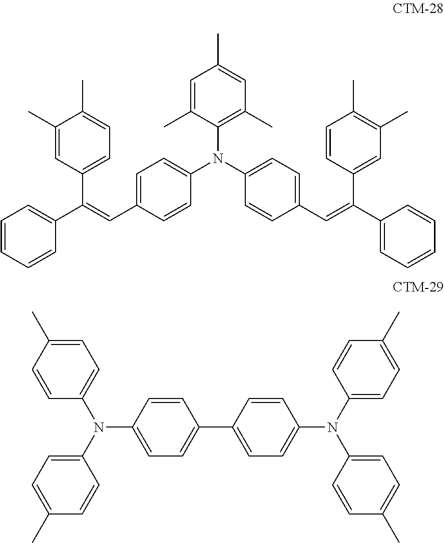 [SMILES: Cc1cc(C)c(N(c2ccc(/C=C(/c3ccccc3)c3ccc(C)c(C)c3)cc2)c2ccc(/C=C(/c3ccccc3)c3ccc(C)c(C)c3)cc2)c(C)c1 ; Cc1ccc(N(c2ccc(C)cc2)c2ccc(-c3ccc(N(c4ccc(C)cc4)c4ccc(C)cc4)cc3)cc2)cc1]

A content of the charge transport material in the composition for forming a protective layer (a coating liquid for forming a protective layer that will be described later) is preferably in the range of 10 to 100 mass parts with respect to the total 100 mass parts of the polymerizable monomer and the polymerizable PFPE compound. It is more preferably in the range of 20 to 60 mass parts.

### (Polymerization Initiator)

It is preferable that a polymerization initiator is further contained in the protective layer or in the composition for forming a protective layer. As a polymerization initiator, a known polymerization initiator may be appropriately used. Examples of a polymerization initiator are: a photopolymerization initiator, a thermal polymerization initiator, a polymerization initiator capable of initiating polymerization by both light and heat. A preferable polymerization initiator is a photopolymerization initiator. Examples thereof are: an acylphosphine oxide compound and an oxime ester compound.

Specific examples of an acylphosphine oxide compound are the following compounds represented by P1 and P2.

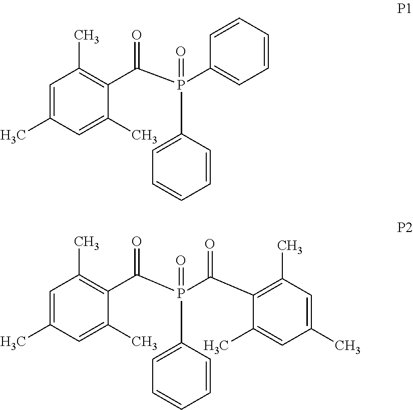

Specific examples of an oxime ester compound are the following compounds represented by P3 and P4.

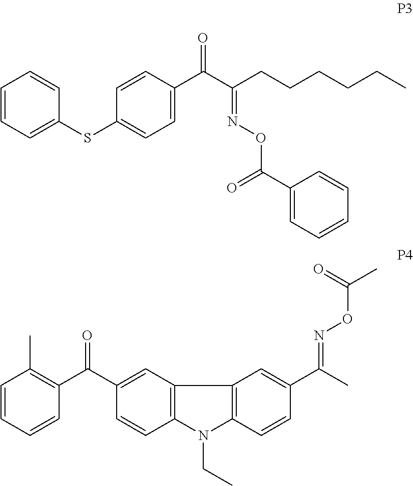

A content of the polymerization initiator in the composition for forming a protective layer (a coating liquid for forming a protective layer that will be described later) is preferably in the range of 0.1 to 20 mass parts with respect to the total 100 mass parts of the polymerizable monomer and the polymerizable PFPE compound. It is more preferably in the range of 0.5 to 10 mass parts. The polymerization initiator may be used alone, or in combination of two or more kinds.

A photopolymerization accelerator having a photopolymerization accelerating effect may be used in combination with the aforementioned photopolymerization initiator. Examples of a photopolymerization accelerator are: triethanolamine, methyldiethanolamine, 4-dimethylaminoethyl benzoate, 4-dimethylaminoisoamyl benzoate, (2-dimethylamino)ethyl benzoate, and 4,4′-dimethylaminobenzophenone.

### (Polymerization Inhibitor)

A polymerization inhibitor having a polymerization inhibiting effect may be further used in the protective layer or in the composition for forming a protective layer. By adding a polymerization inhibitor, a crosslinking density of the polymerizable monomer for forming the protective layer may be adjusted. As a result, occurrence of image flow in the image forming process may be suppressed, and fine adjustment of abrasion rate of the protective layer caused by cleaning of the protective layer may be performed. Any polymerization inhibitor may be used as long as it exhibits the above-mentioned function. It may be suitably selected from known compounds. When the protective layer is formed by curing with a radical polymerization reaction, a polymerization inhibitor is preferably a compound represented by the following Formula (4) from the viewpoint of suppressing occurrence of image flow without decreasing transfer memory property and cleaning property.

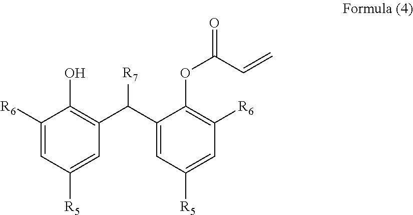

In Formula (4), R₅ and R₆ each independently represent a straight chain or a branched chain alkyl group having 1 to 6 carbon atoms, and R₇ represents a hydrogen atom or a methyl group.

A specific example of a polymerization inhibitor represented by Formula (4) is a compound represented by the following formula. However, the present invention is not limited to this.

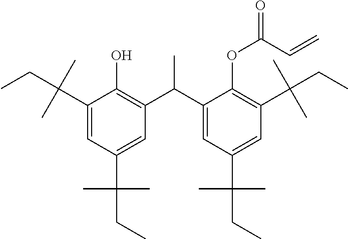 [SMILES: C=CC(=O)Oc1c(C(C)c2cc(C(C)(C)CC)cc(C(C)(C)CC)c2O)cc(C(C)(C)CC)cc1C(C)(C)CC]

An added amount of the polymerization inhibitor may be appropriately adjusted as required within the range where the above-described function can be exhibited. For example, a content of the polymerization inhibitor in the composition for forming a protective layer (a coating liquid for forming a protective layer that will be described later) is preferably in the range of 20 mass parts or less with respect to the total 100 mass parts of the polymerizable monomer and the polymerizable PFPE compound. It is more preferably in the range of 10 mass parts or less.

### <<Production Method of Electrophotographic Photoreceptor>>

An electrophotographic photoreceptor in the embodiment of the present invention may be produced in the same was as preparation of known photoreceptors, except that a polymerizable monomer, a polymerizable perfluoropolyether (PFPE) compound, and metal oxide particles surface-modified with a surface modifying agent (modifier) containing a fluorine atom are used as materials for forming a protective layer.

For example, an electrophotographic photoreceptor of the present invention may be produced by the method containing the following steps (1) to (4).

Step (1): a step of forming an intermediate layer by applying a coating liquid for forming an intermediate layer to an outer peripheral surface of the above-described conductive support, followed by drying the intermediate layer.

Step (2): a step of forming a charge generation layer by applying a coating liquid for forming a charge generation layer to an outer peripheral surface of the intermediate layer formed on the conductive support, followed by drying the charge generation layer.

Step (3): a step of forming a charge transport layer by applying a coating liquid for forming a charge transport layer to an outer peripheral surface of the charge generation layer formed on the intermediate layer, followed by drying the charge transport layer.

Step (4): a step of forming a protective layer by applying a coating liquid for forming a protective layer (the above-described composition) to an outer peripheral surface of the charge transport layer formed on the charge generation layer, followed by irradiating with UV rays to cure the protective layer.

### (Step (1): Formation of an Intermediate Layer)

First, a binder resin for an intermediate layer is dissolved in a solvent to prepare a coating liquid for forming an intermediate layer. Conductive metal oxide particles or insulating metal oxide particles may be dispersed in the coating liquid for forming an intermediate layer may from the viewpoint of adjusting resistance of the intermediate layer.

Subsequently, this coating liquid for forming an intermediate layer is applied on a conductive support with a predetermined thickness to obtain a coating film of the coating liquid for forming an intermediate layer. Then, the coating film is dried to form an intermediate layer.

As a dispersing method for dispersing the above-described metal oxide particles into a coating liquid for forming an intermediate layer, it may be cited: an ultrasonic disperser, a ball mill, a sand mill, and a homo mixer.

As a coating method of a coating liquid for forming an intermediate layer, it may be cited known methods such as: a dip coating method, a spray coating method, a spinner coating method, a bead coating method, a blade coating method, a beam coating method, and a slide hopper method.

A drying method of the coated layer of the coating liquid for forming an intermediate layer may be suitably selected from the known drying methods according to the kinds of solvent and the thickness of the layer. A heat drying method is preferably used, for example.

As a solvent used for a coating liquid for forming an intermediate layer, it is sufficient that it will dissolve the binder resin for the intermediate layer, and it will give a good dispersion property for the metal oxide particles. Examples of a solvent for the coating liquid for forming an intermediate layer are alcohols with 1 to 4 carbon atoms such as: methanol, ethanol, n-propyl alcohol, isopropyl alcohol, n-butanol, t-butanol, and sec-butanol. These alcohols are preferably used in the coating liquid for forming intermediate layer from the viewpoint of solubility of the binder resin and coating property.

Examples of a binder resin in the coating liquid for forming an intermediate layer include: casein, polyvinyl alcohol, nitrocellulose, ethylene-acrylic acid copolymer, polyamide, polyurethane, and gelatin. In particular, the binder resin for the intermediate layer is preferably an alcohol-soluble polyamide. The concentration of the binder resin for the intermediate layer in the coating liquid for forming an intermediate layer may be suitably adjusted according to the layer thickness of the intermediate layer, and the production speed.

Examples of a metal oxide that constitutes the metal oxide particles in the coating liquid for forming an intermediate layer include: aluminum oxide (alumina), zinc oxide, titanium oxide, tin oxide, antimony oxide, indium oxide, and bismuth oxide.

In order to increase the storage stability of a coating liquid for forming an intermediate layerand the dispersion property of the metal oxide particles, an auxiliary solvent may be used. Examples of an auxiliary solvent which may be used with the above-described solvent are: benzyl alcohol, toluene, dichloromethane, cyclohexanone, and tetrahydrofuran.

### (Step (2): Formation of a Charge Generation Layer)

First, a charge generation compound is dispersed in a solution of a binder for a charge generation layer dissolved in a solvent to prepare a coating liquid for forming a charge generation layer. Subsequently, this coating liquid for forming a charge generation layer is applied on the intermediate layer with a predetermined thickness to obtain a coating film of the coating liquid for forming a charge generation layer on the intermediate layer. Then, the coating film is dried to form a charge generation layer.

Examples of a dispersing means for dispersing the charge generation compound in the coating liquid for forming the charge generation layer include the same means as the dispersing means for dispersing the metal oxide particles in the coating liquid for forming the intermediate layer. Examples of a method of applying the coating liquid for forming a charge generation layer include the same methods as the method for coating a coating liquid for forming an intermediate layer. Further, the method for drying the coating film of the coating liquid for forming a charge generation layer may be the same as the method for drying the coating film of the coating liquid for forming an intermediate layer.

Examples of a solvent used for a coating liquid for forming a charge generation layer are: toluene, xylene, dichloromethane, 1,2-dichloroethane, methyl ethyl ketone, cyclohexane, ethyl acetate, t-butyl acetate, methanol, ethanol, propanol, butanol, methyl cellosolve, 4-methoxy-4-methyl-2-pentanone, ethyl cellosolve, tetrahydrofuran, 1,4-dioxane, 1,3-dioxolane, pyridine, and diethylamine.

Examples of a binder resin contained in a coating liquid for forming a charge generation layer include: polystyrene resins, polyethylene resins, polypropylene resins, acrylic resins, methacrylic resins, poly(vinyl chloride) resins, poly(vinyl acetate) resins, poly(vinyl butyral) resins, epoxy resins, polyurethane resin, phenol resins, polyester resins, alkyd resins, polycarbonate resins, silicone resins, and melamine resins, copolymer resins containing two or more of these resins (such as vinyl chloride-vinyl acetate copolymer resins and vinyl chloride-vinyl acetate-maleic anhydride copolymer resins), and poly(vinyl carbazole) resins.

Examples of a charge generation compound include: azo pigments such as Sudan Red and Diane Blue; quinone pigments such as pyrenequinone and anthanthrone; quinocyanine pigments; perylene pigments; indigo pigments such as indigo and thioindigo; and phthalocyanine pigments.

The content of the charge generation compound in the coating liquid for forming a charge generation layer is preferably in the range of 1 to 600 mass parts, more preferably in the range of 50 to 500 mass parts relative to 100 mass parts of the binder resin for a charge generation layer.

### (Step (3): Formation of a Charge Transport Layer)

First, a binder resin for a charge transport layer and a known charge transport compound are dissolved in a solvent to prepare a coating liquid for forming a charge transport layer. Subsequently, the coating liquid for forming a charge transport layer is applied on the charge generation layer with a predetermined thickness to obtain a coating film of the coating liquid for forming a charge transport layer on the charge generation layer. Then, the coating film is dried to form a charge transport layer.

Examples of a method of applying the coating liquid for forming a charge transport layer include the same methods as the method for coating a coating liquid for forming an intermediate layer. Further, the method for drying the coating film of the coating liquid for forming a charge transport layer may be the same as the method for drying the coating film of the coating liquid for forming an intermediate layer.

Examples of a solvent for a coating liquid for forming a charge transport layer include the same solvents used for a coating liquid for forming a charge generation layer.

Examples of a binder resin for a coating liquid for forming a charge transport layer include: polycarbonate resins, polyacrylate resins, polyester resins, polystyrene resins, styrene-acrylonitrile copolymer resins, polymethacrylate resins, and styrene-methacrylate copolymer resins.

A content of the charge transport compound contained in the coating liquid for forming a charge transport layer is preferably in the range of 10 to 500 mass parts with respect to 100 mass parts of the binder resin. More preferably, it is in the range of 20 to 100 mass parts.

### (Step (4): Formation of a Protective Layer)

First, a polymerizable monomer, a polymerizable PFPE compound, and metal oxide particles surface-modified with a surface modifying agent containing a fluorine atom are dissolved in a solvent to prepare a coating liquid for forming a protective layer. According to necessity, other components (for example, the above-mentioned charge transport compound, polymerization initiator, and polymerization inhibitor) may be further added to the coating liquid for forming a protective layer. Then, the prepared coating liquid for forming a protective layer is applied on the charge transport layer to obtain a coating film of the coating liquid for forming a protective layer. Then, the coating film is dried, and active rays are irradiated to the coating film so as to polymerize and cure the polymerizable monomer. Thus, the protective layer is formed.

Through the aforesaid coating, drying, and curing processes, the reaction between the polymerizable monomers, the reaction between the polymerizable monomer and the polymerizable PFPE compound or the polymerizable group possessed by the metal oxide particle respectively progress, and a crosslinked cured resin is formed.

A content of the metal oxide particles contained in the coating liquid for forming a protective layer is preferably in the range of 30 to 200 mass parts with respect to 100 mass parts of the total monomers for forming cured resin (the polymerizable monomer and the polymerizable PFPE compound). More preferably, it is in the range of 50 to 150 mass parts.

A content of the charge transport compound contained in the coating liquid for forming a protective layer is preferably in the range of 10 to 100 mass parts with respect to 100 mass parts of the total monomers for forming cured resin (the polymerizable monomer and the polymerizable PFPE compound). More preferably, it is in the range of 20 to 60 mass parts.

Examples of a dispersing means for dispersing the aforesaid metal oxide particles and charge transport compound in the coating liquid for forming a protective layer include the same means as the dispersing means for dispersing the metal oxide particles in the coating liquid for forming the intermediate layer. Examples of a method of applying the coating liquid for forming a protective layer include the same methods as the method for coating a coating liquid for forming an intermediate layer. In particular, a circular slide hopper is preferably used for coating.

Any solvents which are capable of dissolving or dispersing, the polymerizable monomer, the polymerizable PFPE compound, and the metal oxide particles surface-modified with a surface modifying agent containing a fluorine atom may be used for the coating liquid for forming a protective layer. Examples of a solvent are: methanol, ethanol, n-propyl alcohol, isopropyl alcohol, n-butanol, t-butanol, sec-butanol, benzyl alcohol, toluene, xylene, methyl ethyl ketone, cyclohexane, ethyl acetate, butyl acetate, methyl cellosolve, ethyl cellosolve, tetrahydrofuran, 1,3-dioxane, 1,3-dioxolane, pyridine, and diethylamine.

The irradiation energy and the irradiation time of the active rays may be appropriately determined according to, for example, the type of the light source to be used, the output of the light source, the type of the polymerizable monomer for forming the protective layer. The irradiation energy of the active rays is preferably in the range of 5 to 500 mJ/cm², for example. More preferably, it is in the range of 5 to 10 mJ/cm². The irradiation time of the active rays is preferably in the range of 0.1 seconds to 10 minutes, for example. More preferably, it is in the range of 0.1 seconds to 5 minutes.

Examples of a light source of active rays include: a low-pressure mercury lamp, a middle-pressure mercury lamp, an ultrahigh-pressure mercury lamp, a carbon-arc lamp, a metal halide lamp, a xenon lamp, a flash (pulsed) xenon lamp, and a UV LED. The output power of the light source of active rays is preferably in the range of 0.1 to 5 kW, more preferably, it is in the range of 0.5 to 3 kW. A preferable wavelength of the active rays is in the range of 250 to 400 nm (UV light), for example.

Through the above-described processes, the electrophotographic photoreceptor according to the embodiment of the present invention may be produced.

### <<Image Forming Apparatus>>

An image forming apparatus of the present invention is provided with the above-described electrophotographic photoreceptor. Preferably, the image forming apparatus of the present invention is provided with: a charging unit to charge a surface of the electrophotographic photoreceptor; an exposing unit to form an electrostatic latent image by irradiating light on the surface of the electrophotographic photoreceptor; a developing unit to develop the electrostatic latent image with a toner into a toner image; a transferring unit to transfer the toner image to paper; and a cleaning unit to remove the residual toner on the electrophotographic photoreceptor.

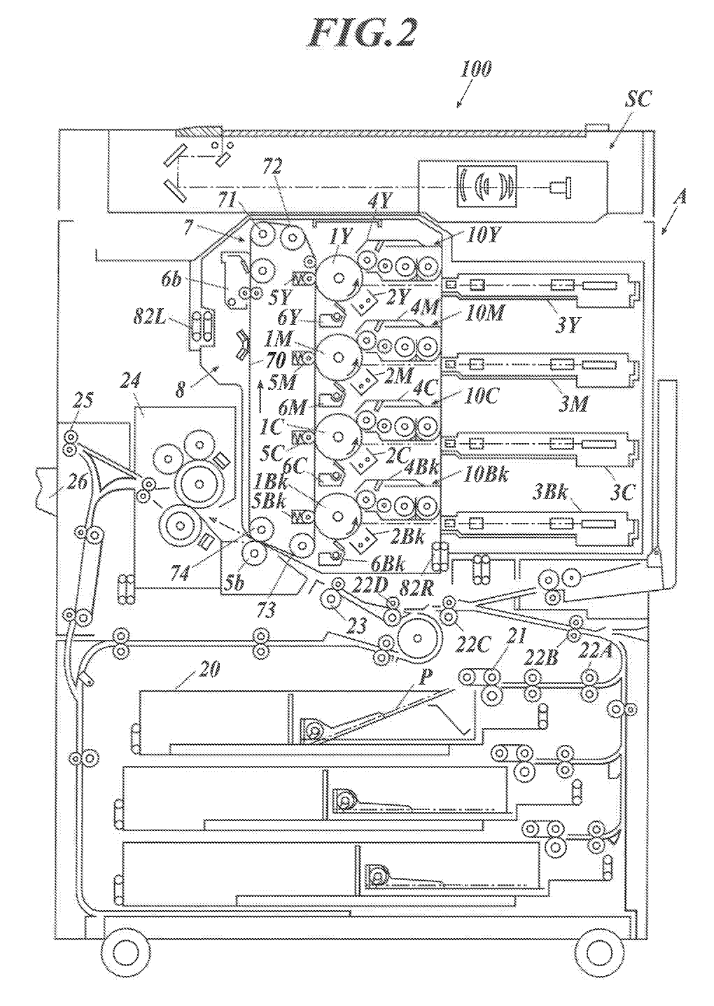

FIG. 2 is a schematic configuration diagram illustrating an example of an image forming apparatus of the present invention.

An image forming apparatus 100 is called as a tandem color image forming apparatus, and it includes four image forming units 10Y, 10M, 10C, and 10Bk, an intermediate transferring unit 7 having an endless belt form, a sheet feeding unit 21, and a fixing unit 24. The image forming apparatus 100 further includes a document scanner SC above a body A of the image forming apparatus.

The image forming unit 10Y that forms a yellow image includes: a drum photoreceptor 1Y; and a charging unit 2Y, an exposing unit 3Y, a developing unit 4Y, a primary transfer roller 5Y, and a cleaning unit 6Y disposed around the photoreceptor 1Y in the rotation order of the photoreceptor 1Y.

The image forming unit 10M that forms a magenta image includes: a drum photoreceptor 1M; and a charging unit 2M, an exposing unit 3M, a developing unit 4M, a primary transfer roller 5M, and a cleaning unit 6M disposed around the photoreceptor 1M in the rotation order of the photoreceptor 1M.

The image forming unit 10C that forms a cyan image includes: a drum photoreceptor 1C; and a charging unit 2C, an exposing unit 3C, a developing unit 4C, a primary transfer roller 5C, and a cleaning unit 6C disposed around the photoreceptor 1C in the rotation order of the photoreceptor 1C.

The image forming unit 10Bk that forms a black image includes: a drum photoreceptor 1Bk; and, a charging unit 2Bk, an exposing unit 3Bk, a developing unit 4Bk, a primary transfer roller 5Bk, and a cleaning unit 6Bk disposed around the photoreceptor 1Bk in the rotation order of the photoreceptor 1Bk.

The electrophotographic photoreceptors described in the embodiment of the present invention are used for the photoreceptors 1Y, 1M, 1C, and 1Bk.

The image forming units 10Y, 10M, 10C, and 10Bk have the same configuration except for the colors of toner images formed on the photoreceptors 1Y, 1M, 1C, and 1Bk. Thus, the following description focuses on the image-forming unit 10Y as an example. The descriptions for the image forming units 10M, 10C, and 10Bk are omitted.

The image forming unit 10Y includes the charging unit 2Y, the exposing unit 3Y, the developing unit 4Y, the primary transfer roller 5Y, and the cleaning unit 6Y, which are disposed around the photoreceptor 1Y being an image forming body. The image forming unit 10Y forms a yellow (Y) toner image on the photoreceptor 1Y. In the embodiment of the present invention, among the members of the image forming unit 10Y, at least the photoreceptor 1Y, the charging unit 2Y, the developing unit 4Y, and the cleaning unit 6Y are installed in an integrated form.

The charging unit 2Y provides the photoreceptor 1Y with a uniform electric potential. For example, the charger of corona discharge mechanism is employed.

The exposing unit 3Y exposes the photoreceptor 1Y provided with the uniform electric potential by the charging unit 2Y in response to image signals (yellow) to form an electrostatic latent image corresponding to the yellow image. The exposing unit 3Y includes light emitting devices (LEDs) arrayed in the axial direction of the photoreceptor 1Y and an imaging element, or includes a laser optical device.

The developing unit 4Y includes: a developing sleeve which includes a magnet and rotating with holding a developer; and a voltage applying device to apply a DC or AC bias voltage between the photoreceptor 1Y and this developing sleeve.

The primary transfer roller 5Y is a device to transfer the toner image formed in the photoreceptor 1Y to the intermediate transfer member 70 in the endless-belt form. The primary transfer roller 5Y is arranged in such a manner to abut the intermediate transfer member 70.

The cleaning unit 6Y includes: a cleaning blade; and a brush roller located in the upstream side of the cleaning blade.

An intermediate transferring unit 7 having an endless belt form is wound by a plurality of rollers 71, 72, 73, and 74. It has an intermediate transferring member 70 in the endless-belt form as a second image carrier of a semiconductor endless belt that is rotatably supported. The intermediate transferring unit 7 is disposed with a cleaning unit 6b that removes the toner on the intermediate transferring member 70.

A housing 8 includes the above-described image-forming units 10Y, 10M, 10C, 10Bk, and intermediate transferring unit 7. The housing 8 has a structure which can be drawn from the apparatus body A via rails 82L and 82R.

As a fixing unit 24, it may be cited a heat-roller type fixing device including: a heat roller incorporating a heat source inside thereof; and a pressure roller which forms a nip portion at the heat roller in such a manner to abut the heat roller.

In the embodiment described above, the image forming apparatus 100 is illustrated as a color laser printer. However, the photoreceptor of the present invention may be applied similarly to a monochromatic laser printer, a copier, or a multifunction peripheral. Further, in this image-forming apparatus, a light source other than a laser, such as an LED light source, may be used as an exposing light source.

An image is formed on a paper P by using the image forming apparatus 100 having the configuration as described above.

At first, the surfaces of the photoreceptors 1Y, 1M, 1C, and 1Bk are negatively charged with the charging units 2Y, 2M, 2C, and 2Bk. Subsequently, the surfaces of the photoreceptors 1Y, 1M, 1C, and 1Bk are exposed corresponding to the image signals by the exposing units 3Y, 3M, 3C, and 3Bk to form an electrostatic latent image. Then, the toners are given to the surface of the photoreceptors 1Y, 1M, 1C, and 1Bk by the developing unit 4Y, 4M, 4C, and 4Bk to develop the electrostatic latent image and to form a toner image of each color.

Then, the color toner images formed on the photoreceptors 1Y, 1M, 1C, and 1Bk are sequentially transferred onto the rotating intermediate transferring member 70 with the respective first transferring rollers 5Y, 5M, 5C, and 5Bk, to form a synthesized color image on the intermediate transferring member 70 (primary transfer).

Then, the toners remained on the surface of the photoreceptors 1Y, 1M, 1C, and 1Bk are removed with the cleaning units 6Y, 6M, 6C, and 6Bk. Afterward, the photoreceptors 1Y, 1M, 1C, and 1Bk are negatively charged with the charging units 2Y, 2M, 2C, and 2Bk for the next image forming process.

On the other hand, a paper P accommodated in a sheet feeding cassette 20 is fed by the sheet feeding unit 21, and it is transported to a second transferring unit 5b via multiple intermediate rollers 22A, 22B, 22C, and 22D and register rollers 23. A color image is transferred (second transfer) to the paper P by the second transferring unit 5b.

The paper P transferred with a color image is subjected to a fix treatment with the fixing unit 24. The paper P is then pinched between discharging rollers 25 and is conveyed to a sheet receiving tray 26 provided outside of the apparatus. After separation of the paper P from the intermediate transferring member 70, the residual toner on the intermediate transferring member 70 is removed by the cleaning unit 6b. Thus, an image is formed on the paper P.

Although the embodiments of the present invention have been described and illustrated in detail, the disclosed embodiments are made for purpose of illustration and example only and not limitation. The scope of the present invention should be interpreted by terms of the appended claims.

### Examples

Hereafter, the present invention will be described specifically by referring to Examples, however, the present invention is not limited to them. In Examples, the term “parts” or “%” is used. Unless particularly mentioned, it represents “mass parts” or “mass %”.

### <<Synthesis of Polymerizable PFPE Compound: PFPE-3>>

14.4 mass parts of perfluoropolyether (P-1) having a hydroxy group at both terminals and represented by the following formula, 0.01 mass parts of p-methoxyphenol as a polymerization inhibitor, 0.01 mass parts of dibutyltin dilaurate as a urethane forming catalyst, 10 mass parts of methyl ethyl ketone were mixed. The mixture was stirred under an air stream and the temperature thereof was raised to 80° C.

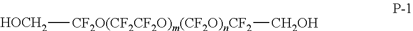

In the above-described formula, an average value of m is 8, and an average value of n is 5.

Then, 2.8 mass parts of 2-(acryloyloxy)ethyl isocyanate were added to the mixture. The reaction was carried out by stirring the mixture at 80° C. for 10 hours.

After confirming the disappearance of the absorption peak in the vicinity of 2360 cm⁻¹ derived from an isocyanate group by IR spectrum measurement, the solvent was distilled off. Thus, 17.2 mass parts of polymerizable PFPE compound PFPE-3 (X: an acryloyloxy group; an average value of m is 8; and an average value of n is 8) were obtained.

### <<Synthesis of Polymerizable PFPE Compound: PFPE-5>>

21.8 mass parts of perfluoropolyether (P-2) having a hydroxy group at both terminals and represented by the following formula, 0.01 mass parts of p-methoxyphenol, 0.01 mass parts of dibutyltin dilaurate, 20 mass parts of methyl ethyl ketone were mixed. The mixture was stirred under an air stream and the temperature thereof was raised to 80° C.

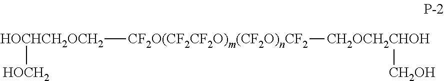

In the above-described formula, an average value of m is 12, and an average value of n is 7.

Then, 6.2 mass parts of 2-(methacryloyloxy)ethyl isocyanate were added to the mixture. The reaction was carried out by stirring at 80° C. for 10 hours.

After confirming the disappearance of the absorption peak in the vicinity of 2360 cm⁻¹ derived from an isocyanate group by IR spectmm measurement, the solvent was distilled off. Thus, 28.0 mass parts of polymerizable PFPE compound PFPE-5 (X: an methacryloyloxy group; an average value of m is 12; and an average value of n is 7) were obtained.

### <<Synthesis of Polymerizable PFPE Compound: PFPE-12>>

5.0 mass parts of cyclic trimer of hexamethylene diisocyanate, 0.01 mass parts of p-methoxyphenol, 0.01 mass parts of dibutyltin dilaurate, and 15 mass parts of Vertrel™ XF (made by Mitsui Du Pont-Mitsui Fluorochemicals Co. Ltd.) were mixed. The mixture was stirred under an air stream and the temperature thereof was raised to 50° C. Further, 2.3 mass parts of hydroxyethyl acrylate were added to the mixture, and the mixture was stirred for 3 hours. Then, a solution containing 20. 3 mass parts of perfluoropolyether (P-3) having a hydroxy group at one terminal and represented by the following formula dissolved in 15 mass parts of Vertrel™ XF was added dropwise. The reaction was carried out by stirring the mixture at 50° C. for 6 hours.

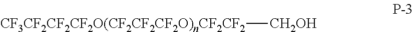

In the above-described formula, an average value of n is 10.

After confirming the disappearance of the absorption peak in the vicinity of 2360 cm⁻¹ derived from an isocyanate group by IR spectmm measurement, the solvent was distilled off. Thus, 27.6 mass parts of polymerizable PFPE compound PFPE-12 (X: an acryloyloxy group; and an average value of n is 10) were obtained.

### <<Preparation of Surface Modifying Agent Containing a Fluorine Atom (A)>>

In a reaction vessel were placed 9.9 g of 2,2,3,3,4,4,4-heptafluorobutyl methacrylate, 0.1 g of acrylic acid, 0.3 g of polymerization initiator “PEROYL™ SA” (made by NOF Co. Ltd.), and 60.0 g of methyl perfluorobutyl ether (fluorine solvent) (made by Tokyo Chemical Industry Co. Ltd.). A dry nitrogen gas was introduced in the reaction vessel to purge the air and the reaction vessel was sealed hermetically. The mixture was heated at 70° C. for 24 hours with stirring. Afterward, the reaction vessel was cooled, and then opened. Subsequently, the liquid in the reaction vessel was poured into 300 mL of methanol. The produced polymer was precipitated, and then, it was dried under a vacuum condition to obtain a surface modifying agent containing a fluorine atom (A) composed of 2,2,3,3,4,4,4-heptafluorobutyl methacrylate/acrylic acid copolymer.

### <<Preparation of Surface Modifying Agent Containing a Fluorine Atom (B)>>

The reaction was done in the same manner as preparation of the surface modifying agent containing a fluorine atom (A), except that 2,2,3,3,4,4,4-heptafluorobutyl methacrylate was replaced with 2,2,3,3-tetrafluoropropyl methacrylate, and acrylic acid was replaced with methacrylic acid. Thus, a surface modifying agent containing a fluorine atom (B) composed of 2,2,3,3-tetrafluoropropyl methacrylate/methacrylic acid copolymer was obtained.

### <<Preparation of Surface Modifying Agent Containing a Fluorine Atom (C)>>

The reaction was done in the same manner as preparation of the surface modifying agent containing a fluorine atom (A), except that 2,2,3,3,4,4,4-heptafluorobutyl methacrylate was replaced with 2,2,3,3,4,4,5,5,5-nonafluoropentyl methacrylate. Thus, it was obtained a surface modifying agent containing a fluorine atom (C) composed of 2,2,3,3,4,4,5,5,5-nonafluoropentyl methacrylate/acrylic acid copolymer.

In addition, the surface modifying agents containing a fluorine atom (A) to (C) each respectively contain the above-described structural unit represented by Formula (1a) and the above-described structural unit represented by Formula (1b).

### <<Preparation of Metal Oxide Particles 1>>

5 g of tin oxide (having a number average primary particle size of 20 nm) as unprocessed metal oxide particles was added in 10 mL of methanol. The mixture was dispersed for 30 minutes by using a US homogenizer. Then, 0.25 g of 3-methacryloxypropyl-trimethoxysilan (KBM503, made by Shin-Etsu Chemical Co. Ltd.) as a coupling agent and 10 mL of toluene were added to the mixture, and the mixture was stirred at room temperature for 1 hours. After removing the solvent from the mixture by evaporator, the mixture was heated at 120° C. for one hour to obtain metal oxide particles (a) surface-modified with a polymerizable group.

5 g of the obtained metal oxide particles (a) was added to 40 g of 2-butanol. The mixture was dispersed for 60 minutes by using a US homogenizer. Then, 10 g of methyl perfluorobutyl ether and the above-described surface modifying agent containing a fluorine atom (A) were added to the mixture. The mixture was further dispersed for 60 minutes by using a US homogenizer. After dispersion, the solvent was evaporated at room temperature. Then, the mixture was heated at 80° C. for 60 minutes to obtain metal oxide particles 1.

### <<Preparation of Metal Oxide Particles 2 to 14>>

Metal oxide particles 2 to 14 were prepared in the same manner as preparation of the above-described metal oxide particles 1, except that the kind of unprocessed metal oxide particles, the number average primary particle size, the kind and the added amount of the surface modifying agent having a polymerizable group, and the kind and the added amount of the surface modifying agent containing a fluorine atom were changes as described in Table I.

In Table I, KBM5803 indicates methacryloxyoctyltrimethoxysilane (made by Shin-Etsu Chemical Co. Ltd.). A surface modifying agent containing a fluorine atom (D) indicates (tridecafluoro-1,1,2,2-tetrahydrooctyl) trimethoxysilane. A surface modifying agent containing a fluorine atom (E) indicates Fluorolink™ S10 (made by Solvay Specialty Polymers Japan Co. Ltd.). The surface modifying agent containing a fluorine atom (D) and the surface modifying agent containing a fluorine atom (E) do not contain at least one of the above-described structural unit represented by Formula (1a) and the above-described structural unit represented by Formula (1b).

### <<Preparation of Metal Oxide Particles 15>>

Metal oxide particles 15 were prepared in the same manner as preparation of the above-described metal oxide particles 1, except that the surface modification treatment was not done by using a surface modifying agent having a polymerizable group, and the added amount of the surface modifying agent containing a fluorine atom was changed as described in Table I.

### <<Preparation of Metal Oxide Particles 16>>

Metal oxide particles 16 were prepared in the same manner as preparation of the above-described metal oxide particles 1, except that the added amount of the surface modifying agent having a polymerizable group was changed as described in Table I, and the surface modification treatment was not done by using a surface modifying agent containing a fluorine atom.

TABLE I

| | Unprocessed | | Surface | | | |
|---|---|---|---|---|---|---|
| | metal oxide | | modifying | | Surface | |
| | particles | | agent having | | modifying agent | |
| | | Number | a polymerizable | | containing a | |
| | | average | group | | fluorine atom | |
| Metal | | primary | | Added | | Added |
| oxide | | particle | | amount | | amount |
| particles | | size | | (mass | | (mass |
| No. | Kind | (nm) | Kind | %) | Kind | %) |
| 1 | SnO₂ | 20 | KBM503 | 5 | [A] | 5 |
| 2 | SnO₂ | 50 | KBM503 | 4 | [A] | 4 |
| 3 | SnO₂ | 100 | KBM503 | 3 | [A] | 3 |
| 4 | SnO₂ | 200 | KBM503 | 2 | [A] | 2 |
| 5 | SnO₂ | 250 | KBM503 | 2 | [A] | 2 |
| 6 | TiO₂ | 200 | KBM503 | 2 | [A] | 2 |
| 7 | Al₂O₃ | 300 | KBM5803 | 2 | [A] | 2 |
| 8 | SiO₂ | 80 | KBM503 | 2 | [A] | 4 |
| 9 | SnO₂ | 20 | KBM503 | 3 | [B] | 7 |
| 10 | BaSO₄/SnO₂ | 100 | KBM503 | 3 | [C] | 3 |
| | Composite | | | | | |
| | particles | | | | | |
| 11 | SnO₂ | 100 | KBM503 | 3 | [D] | 3 |
| 12 | SnO₂ | 100 | KBM503 | 3 | [E] | 3 |
| 13 | SnO₂ | 20 | KBM503 | 5 | [D] | 5 |
| 14 | SiO₂ | 20 | KBM503 | 7 | [E] | 7 |
| 15 | SnO₂ | 100 | — | — | [A] | 6 |
| 16 | SnO₂ | 100 | KBM503 | 6 | — | — |

### <<Production of Electrophotographic Photoreceptor 101>>

### (1) Preparation of Conductive Support

A conductive support was prepared through milling the surface of a cylindrical aluminum support.

### (2) Formation of Intermediate Layer

The following components were mixed. The mixture was subjected to a dispersion treatment of a batch method with a sand mill for 510 hours to obtain a coating liquid for forming an intermediate layer.

| | | |
|---|---|---|
| Polyamide resin “X 1010” (made by Daicel-Degussa | 10 | mass parts |
| Ltd.) | | |
| Titanium oxide “SMT500SAS” (mad by TEIKA Co. | 1 | mass parts |
| Ltd.) 1 | | |
| Ethanol | 200 | mass parts |

The coating liquid for forming an intermediate layer was applied to a surface of the conductive support through dip coating. Subsequently, the coated layer was dried at 110° C. for 20 minutes to obtain an intermediate layer having a thy film thickness of 2 μm.

### (3) Formation of Charge Generation Layer

A coating liquid for forming a charge generation layer was prepared through mixing of the following materials with a circulating ultrasonic homogenizer “RUS-600 TCVP” (made by Nissei Corporation). The dispersion was done under the conditions of 19.5 kHz, 600 W, circulating flow amount of 40 L/h for 0.5 hours.

The above-described liquid for forming a charge generation layer was applied onto the intermediate layer through dip coating, and the resultant film was dried to form a charge generation layer having a thickness of 0.3 μm.

Charge Generation Material:

| | | |
|---|---|---|
| Titanylphthalocyanine (having at least a maximum | 24 | mass parts |
| diffraction peak at 8.3°, 24.7°, 25.1°, and 26.5° | | |
| as measured by Cu-Kα X-ray diffractometry) with | | |
| (2R,3R)-2,3-butandiol (1:1 aduct) and non-adduct of | | |
| titanylphthalocyanine (mixed crystal) | | |
| Poly(vinyl butyral) resin “S-LEC BL-1” (made by | 12 | mass parts |
| Sekisui Chemical Co. Ltd.) | | |
| 3-Methyl-2-butanone/cyclohexanone (volume ratio = | 400 | mass parts |
| 4:1) | | |

The coating liquid for forming a charge generation layer was applied on the intermediate layer through dip coating. Then, the coated layer was dried to obtain a charge generation layer having a dry film thickness of 0.3 μm.

### (4) Formation of Charge Transport Layer

A coating liquid for forming a charge transport layer was prepared through mixing and dissolution of the following materials.

| | | |
|---|---|---|
| Charge transport material: Formula A | 60 | mass parts |
| Polycarbonate resin “Z300” (made by Mitsubishi Gas | 100 | mass parts |
| Chemical Co. Inc.) | | |
| Antioxidant: Irganox 1010 (made by BASF Japan Co. | 4 | mass parts |
| Ltd.) | | |

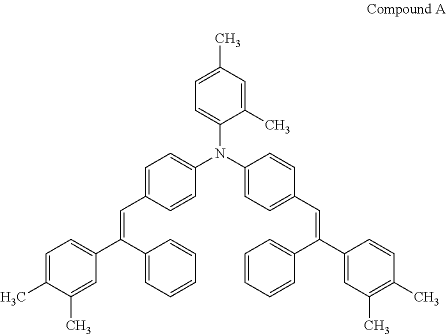

The prepared coating liquid for forming a charge transport layer was applied onto the charge generation layer through dip coating, and the resultant film was dried at 120° C. for 70 minutes to form a charge transport layer having a dry film thickness of 24 μm.

### (5) Formation of Protective Layer

A coating liquid for forming a protective layer was prepared by dissolving and dispersing the following materials.

| | | |
|---|---|---|
| Polymerizable monomer M2 | 60 | mass parts |
| Polymerizable PFPE compound: Fomblin ™ | | |
| MT70 (made by Solvay Specialty Polymers | 20 | mass parts |
| Japan Co. Ltd.) | | |
| Charge transport material CTM-13 | 20 | mass parts |
| Metal oxide particles 1 | 100 | mass parts |
| Polymerization initiator (“Irgacure 819” made | 5 | mass parts |
| by BASF Japan Co. Ltd.) | | |
| 2-Butanol | 300 | mass parts |
| Tetrahydrofuran | 30 | mass parts |

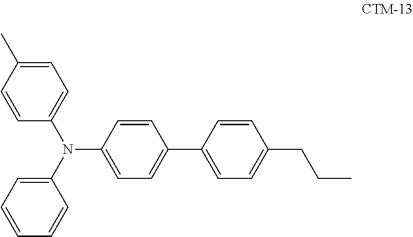 [SMILES: CCCc1ccc(-c2ccc(N(c3ccccc3)c3ccc(C)cc3)cc2)cc1]

The obtained coating liquid for forming a protective layer was applied on the charge transport layer with a circular slide hopper coating apparatus to form a coated layer. The coated layer was irradiated with UV rays with a metal halide lamp for 1 minute. Then the coated layer was dried to obtain a protective layer having a dry film thickness of 3.0 μm. An electrophotographic photoreceptor 101 was thus produced.

### <<Production of Electrophotographic Photoreceptors 102 to 118>>

Electrophotographic photoreceptors 102 to 118 were produced in the same manner as production of the electrophotographic photoreceptor 101 except that a polymerizable monomer, a polymerizable PFPE compound, and metal oxide particles used for forming a protective layer were changed as described in Table II.

In Table II, MT70 represents Fomblin™ MT70 (made by Solvay Specialty Polymers Japan Co. Ltd.). MD700 represents Fluorolink™ MD700 (made by Solvay Specialty Polymers Japan Co. Ltd.). AD1700 represents Fluorolink™ AD1700 (made by Solvay Specialty Polymers Japan Co. Ltd.). In addition, MD700/AD177 represents a mixture of MD700 and AD177 with a mass ratio of 1:1. MT70/MD700 represents a mixture of MT70 and MD700 with a mass ratio of 1:1. MT70, MD700, and AD1700 each contain a structure represented by the above-described Formula (2).

### <<Production of Electrophotographic Photoreceptor 119>>

Electrophotographic photoreceptor 119 was produced in the same manner as production of the electrophotographic photoreceptor 101 except that a polymerizable PFPE compound was not used and an added amount of the polymerizable monomer was changed to 80 mass parts for forming a protective layer.

### <<Evaluation of Electrophotographic Photoreceptors 101 to 119>>

The produced electrophotographic photoreceptors 101 to 119 as described above were subjected to the following evaluations. The evaluation results are listed in Table II.

An full-color image forming apparatus “bizhub PRO™ C6501” (made by Konica Minolta, Inc.) was used as an evaluation apparatus. The produced electrophotographic photoreceptors were each respectively loaded to that apparatus. An endurance test (abrasion resistance test) was conducted by continuously printing 100,000 sheets of A4 paper having thereon two vertical belt-shaped solid images with a width of 4 cm in the A4 sideway feed under the conditions of a temperature of 30° C. and a humidity of 85% RH.

Then, abrasion resistance of electrophotographic photoreceptor, cleaning property, and coverage density difference each were evaluated as described below.

### <Evaluation of Abrasion Resistance>

The decreased amount of the layer thickness of the electrophotographic photoreceptor before and after the above-described endurance test was measured and evaluated.

The specific evaluation way was as follows. The thickness of the electrophotographic photoreceptor was measured at 10 points corresponding to the region of the vertical belt-shaped solid image, and at 10 points corresponding to the region without the vertical belt-shaped solid image. Both end portions in the axial direction of the electrophotographic photoreceptor tend to have uneven layer thicknesses. Therefore a region of 3 cm from both end portions is avoided for measurement. The average value thereof was decided to be the thickness of the electrophotographic photoreceptor.

As a thickness measurement apparatus, “EDDY 560C” (apparatus using an eddy current method, made by HELMUT FISHER GMBTE Co.) was used. The difference of the thickness between before and after the abrasion resistance test was calculated. The obtained decreased amount was evaluated according to the following evaluation criteria. When the evaluation results were “A” or “B”, the sample was judged to be practical.

A: Decreased amount is 0.1 μm or less

B: Decreased amount is larger than 0.1 μm and not larger than 0.2 μm

C: Decreased amount is larger than 0.2 μm

### <Evaluation of Cleaning Property>

After conducting the above-described endurance test, a half tone image was printed on 100 sheets of A3 neutral paper under the conditions of a temperature of 10° C. and a humidity of 15% RH. The printed half tone image has a black image portion located at the front portion in the paper conveyance direction, and a white background portion located at the rear portion in the paper conveyance direction.

The white background portion of the 100th sheet was visually observed. The toner slipping was evaluated according to the following criteria. When the evaluation results were “A” or “B”, the sample was judged as acceptable.

A: No stain is observed on the white background portion

B: Slight stripe-shaped stain is observed on the white background portion, but there is no practical problem.

C: Distinct stripe-shaped stain is observed on the white background portion, and there is a practical problem.

### <Evaluation of Coverage Density Difference>

After conducting the above-described endurance test, a half tone image was printed on the whole surface of A3 neutral paper.

The image densities were measured at 5 points corresponding to the region of the vertical belt-shaped solid image of the test image in the above-described endurance test, and 5 points corresponding to the region without the vertical belt-shaped solid image in the present test. The difference of the average density value of each portion was calculated. The evaluation was done according to the following criteria. When the evaluation results were “A” or “B”, the sample was judged to be practical.

A: Density difference is 0.05 or less

B: Density difference is larger than 0.05 and not more than 0.10

C: Density difference is larger than 0.10

TABLE II

| | Composition | | | | | | |
|---|---|---|---|---|---|---|---|
| | | | Metal | Evaluation results | | | |
| | | | oxide | Abrasion | | Coverage | |
| Electrophotographic | Polmerizable | Polmerizable | particles | resistance | Cleaning | density | |
| photoreceptor No. | monomer | PFPE compound | No. | property | property | difference | Remarks |
| 101 | M2 | MT70 | 1 | B | A | A | Present |
| | | | | | | | invention |
| 102 | M2 | MT70 | 2 | A | A | A | Present |
| | | | | | | | invention |
| 103 | M2 | MT70 | 3 | A | A | A | Present |
| | | | | | | | invention |
| 104 | M2 | MT70 | 4 | A | A | A | Present |
| | | | | | | | invention |
| 105 | M2 | MT70 | 5 | A | B | A | Present |
| | | | | | | | invention |
| 106 | M2 | MT70 | 6 | A | A | A | Present |
| | | | | | | | invention |
| 107 | M2 | MT70 | 7 | A | B | A | Present |
| | | | | | | | invention |
| 108 | M6 | MD700 | 8 | A | A | A | Present |
| | | | | | | | invention |
| 109 | M6 | AD1700 | 9 | B | B | A | Present |
| | | | | | | | invention |
| 110 | M8 | MD700/AD1700 | 10 | A | A | A | Present |
| | | (mass ratio = | | | | | invention |
| | | 1:1) | | | | | |
| 111 | M2 | MT70 | 11 | A | A | B | Present |
| | | | | | | | invention |
| 112 | M7 | MT70 | 12 | A | A | B | Present |
| | | | | | | | invention |
| 113 | M2 | MD700/AD1700 | 13 | B | B | B | Present |
| | | (mass ratio = | | | | | invention |
| | | 1:1) | | | | | |
| 114 | M7 | PFPE-3 | 14 | B | B | B | Present |
| | | | | | | | invention |
| 115 | M2 | PFPE-5 | 3 | A | A | A | Present |
| | | | | | | | invention |
| 116 | M2 | PFPE-12 | 3 | B | B | A | Present |
| | | | | | | | invention |
| 117 | M2 | MT70 | 15 | B | A | A | Present |
| | | | | | | | invention |
| 118 | M2 | PFPE-5 | 16 | B | B | C | Comparative |
| | | | | | | | example |
| 119 | M2 | — | 1 | C | C | C | Comparative |
| | | | | | | | example |

As indicated in Table II, the electrophotographic photoreceptors 101 to 117 exhibited excellent results in each evaluation when compared with the electrophotographic photoreceptors 118 and 119. Therefore, it can be said that the electrophotographic photoreceptors 101 to 117 are excellent in abrasion resistance, and they sustain high cleaning performance, and they suppress occurrence of image defect due to uneven abrasion.

What is claimed is:

1. An electrophotographic photoreceptor comprising a conductive support having thereon a photosensitive layer and a protective layer located on the photosensitive layer,
wherein the protective layer contains a polymerized and cured product of a composition incorporating: a polymerizable monomer, a polymerizable perfluoropolyether compound, and metal oxide particles surface-modified with a surface modifying agent containing a fluorine atom.

2. The electrophotographic photoreceptor described in claim 1,
wherein the surface modifying agent containing a fluorine atom includes a fluoroalkyl (meth)acrylate/(meth)acrylic acid copolymer.

3. The electrophotographic photoreceptor described in claim 2,
wherein the fluoroalkyl (meth)acrylate/(meth)acrylic acid copolymer contains both a structure unit represented by Formula (1a) and a structure unit represented by Formula (1b), 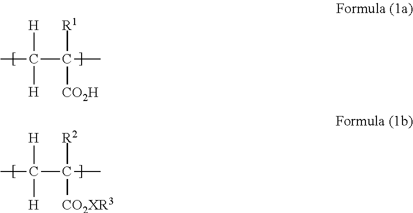
in Formula (1a) and Formula (1b), R¹ and R² each independently represents a hydrogen atom or a methyl group; X represents an alkylene group having 1 to 4 carbon atoms; and R³ represents a perfluoroalkyl group having 1 to 6 carbon atoms.

4. The electrophotographic photoreceptor described in claim 1,
wherein the metal oxide particles surface-modified with the surface modifying agent containing a fluorine atom has a polymerizable group.

5. The electrophotographic photoreceptor described in claim 1,
wherein the metal oxide particles surface-modified with the surface modifying agent containing a fluorine atom has a number average primary particle size in the range of 50 to 200 nm.

6. The electrophotographic photoreceptor described in claim 1,
wherein the polymerizable perfluoropolyether compound has a structure represented by Formula (2),
(X)_{q}-A-CF₂O(CF₂CF₂O)ₘ(CF₂O)ₙCF₂-A-(X)_{q} Formula (2)
in Formula (2), A represents a linking group having a (q+1) valence, and two As may be the same or different; X represents a polymerizable group, and a plurality of Xs may be the same or different; m and n each independently represent an integer of 0 or more, and (m+n)≥5; and q represents an integer of 1 or more, and a plurality of Xs may be the same or different.

7. An image forming apparatus provided with the electrophotographic photoreceptor described in claim 1.
